(19) United States
(12) Patent Application Publication
(10) Pub. No.: US 2006/0027709 A1
(43) Pub. Date: Feb. 9, 2006

(54) Apparatus comprising of propulsion system

(75) Inventor: Fabrizio Pinto, Monrovia, CA (US)

Correspondence Address: DEMONT & BREYER, LLC, SUITE 250, 100 COMMONS WAY, HOLMDEL, NJ, 07733, US

(73) Assignee: InterStellar Technologies Corporation, Monrovia, CA (US)

(21) Appl. No.: 11/197,787

(22) Filed: Aug. 4, 2005

Related U.S. Application Data
(60) Provisional application No. 60/598,658, filed on Aug. 4, 2004.

(51) Int. Cl. B64G 1/40

(52) U.S. Cl. 244/171.1

(57) ABSTRACT

A propulsion system that does not consume fuel. The system operates to modify the dispersion force (i.e., van der Waals) that arises between particles, such as neutral atoms. A lifting force is generated as a result of this modification of the dispersion force. In the illustrative embodiment, the propulsion system includes particles, a particle trap, a source of electromagnetic energy, and a piston.

### STATEMENT OF RELATED APPLICATION

This application claims priority of U.S. Provisional Patent Application 60/598,658, which was filed on Aug. 4, 2004 and is incorporated by reference herein.

### FIELD OF THE INVENTION

The present invention relates generally to propulsion systems.

### BACKGROUND OF THE INVENTION

Sixty-six years after the Wright brothers made their first, sustained powered flight, Neil Armstrong walked on the Moon. Incredible progress to be sure, but can this pace of innovation be sustained? Will we soon visit neighboring planets or the nearest stars? Can we reach these destinations with the technology that got us to the Moon? If we can't, what propulsion technologies might be able to take us to these unthinkably remote places?

Current propulsion technology is based on an action-reaction principle, whereby a gas is expelled at high-speed to propel a payload in the opposite direction. This technology is typically embodied as a chemical rocket engine. While a payload can be rapidly accelerated using a chemical rocket, fuel is quickly consumed to develop the required thrust. To illustrate the problem, consider that if a spacecraft could be powered to achieve a constant acceleration of only 1 g, the trip from Earth to Mars would require about 2-4 days. In fact, modern chemical rocket engines can achieve accelerations much greater than 1 g. But even at 1 g, the fuel would be exhausted within minutes. As a consequence, the trip to Mars from Earth via chemical rocket takes about six months.

With current chemical-rocket technology, most of the weight at launch is fuel. For example, a typical choice for a mission to Mars would involve the Boeing Delta II 7925 or 7925H rocket stages. In its common configuration, the RS-27A engine of the Delta II first stage, along with an additional nine strap-on sold rocket motors, will have a mass of about 285,000 kilograms at launch. But of this mass, only slightly more than 1000 kilograms will reach Mars.

As noted above, the delivery of several tons of a payload to Mars via chemical rockets is contemplated to take about six months, with total mission duration of about two to three years. For the majority of transit time, astronauts will be weightless, which is known to adversely affect the human body. Furthermore, the astronauts will be subject to exposure from harmful radiation. Additionally, the prospects of mounting a rescue or recovering from a serious malfunction are slim due to the transit times involved.

And the distances involved in interstellar travel are so large that with this technology, a trip to even the nearest star systems would take hundreds to thousands of years.

It seems clear that current technology does not provide a means to manned exploration of the Solar System or beyond. That being the case, can technological approaches be conceived that will send spacecraft from the Earth to destinations within the Solar System in a matter of days or weeks, as opposed to years or decades? Any such approach will face a daunting technological requirement. Namely, in order to drastically reduce travel time to “neighboring” planets and “nearby” stars, exceedingly large velocities must be achieved—velocities that are on the order of a significant fraction of the speed of light.

Proposals that meet this mission time requirement will, therefore, typically require what can only be described as “fantastic” technologies. From a feasibility perspective, perhaps the most “promising” of those technologies that have been proposed is the matter-antimatter drive. When combined, matter and antimatter will completely annihilate, releasing unfathomable quantities of energy. But even if we were able to develop a matter-antimatter drive, its use should be proscribed. The reason is that if antimatter were to leak from its containment chamber while in the vicinity of Earth, there is a distinct possibility that the resulting energy release would destroy Earth or at least cause the extinction of all life thereon.

Another exotic propulsion technology is the “solar sail.” Although solar sails can produce momentum by reflecting a portion of the light that they receive from the sun, this approach, on its own, does not offer a solution to the problem of achieving interstellar or even interplanetary travel. More specifically, in order to deliver a space probe to a nearby star in less than a century, the sail must be driven by laser light aimed at it throughout the trip. The power requirement for the laser, which would be located on Earth, is on the order of hundreds of thousands of terawatts. For the sake of comparison, the current planetwide consumption of electricity is on the order of about 1 terawatt. And this approach has a further complication. Namely, the craft must be slowed from a non-trivial fraction of the speed of light to orbital velocity at its final destination using light that is coming from earth. This would require the coordination of very complex maneuvers that, if not carried out correctly, might result in the destruction of the ecosystem of the destination planet.

In the late 1990s, NASA established and funded a program, now defunct, called the “Breakthrough Propulsion Program.” The program's charter was to evaluate entirely new propulsive principles that would enable interstellar or at least interplanetary travel. Technologies under consideration included the Schlicher thruster, Deep Dirac Energy, Podkletnov gravity shielding, Podkletnov force-beam, transient inertia, coupling between electromagnetism and spacetime, gravity modification schemes, anomalous heat effect, Biefeld-Brown effect, warp drives, wormholes, high-frequency gravitational waves, superluminal tunneling, the Slepian Drive, and the quantum vacuum (e.g., dynamical Casimir effect, etc.).

Unfortunately, none of these approaches were deemed to be promising. For example, one study pertaining to the quantum vacuum concluded that the acceleration of a spacecraft propelled by the dynamical Casimir effect would, after ten years under acceleration, be traveling at 0.1 meters per second!

In light of the foregoing, it seems likely that an as yet unidentified propulsion technology will be required to make routine, manned interplanetary and interstellar travel a reality.

### SUMMARY

The illustrative embodiment of the present invention is a system and method for propulsion that avoids some of the drawbacks of the prior art. Unlike conventional propulsion technology, the propulsion system described in this specification does not consume fuel (although there is an energy requirement). In fact, the system does not even use fuel, as the term is commonly used.

The illustrative embodiment is grounded in accepted physics principles, albeit leading-edge theoretical, experimental and applied physics. The propulsion method does not violate basic physical “laws,” such as the conversation of momentum. The equations on which the propulsion system is based are clearly established in the art, although extended to a domain of applicability and mode of use that has not been previously contemplated.

The propulsion system operates by modifying the dispersion force (i.e., van der Waals) that arises between particles, such as neutral atoms. The following two discoveries by the inventor enable the propulsion system:
(1) The dispersion force interaction between any two neutral atoms is affected by the presence of an external gravitational field in a way that results in a repulsive force upon the atomic pair.
(2) The distortion of the dispersion interaction described above, which is usually quite small and is proportional to the number of atoms present, can be magnified by many orders of magnitude. This requires that (a) the atom-atom interaction to be transformed from a relatively shorter-range interaction to a relatively longer-range interaction; and (b) a very large number of atoms are present for mutual interaction.

A method in accordance with the illustrative embodiment of the present invention comprises:
generating a lifting force by subjecting a plurality of confined particles to a trigger acceleration; and
exposing the particles to an amount of electromagnetic radiation that is sufficient to induce the lifting force to:
   (i) exhibit relatively long-range interactions; and
   (ii) increase the momentum of the particles; and
transferring at least a portion of the increase in momentum to a vehicle.

To begin the propulsion cycle, the particles must be subjected to acceleration, that is, the “trigger” acceleration. This can be accomplished, for example, by supporting a craft that contains the propulsion system in a gravitational field (i.e., the craft cannot be in free fall). Or, acceleration can be kinematic, such as by rotating the craft, or using a conventional propulsion system to accelerate the craft. The force is referred to as a “lifting” force because it's direction is opposite to the weight of the particles.

In the illustrative embodiment, the particles are neutral atoms, the atoms are confined in an atomic trap, and a laser provides the electromagnetic energy that is required to transform the atom-atom interaction from a short-range to a long-range interaction and to increase the momentum of the atoms.

Some of the increase in momentum of the atoms is transferred to a vehicle, such as a spacecraft. This transfer of momentum propels the vehicle. In the illustrative embodiment, this is accomplished by letting the atoms work against a piston, which in turn impacts against a part of the vehicle. Atoms that hit the piston are recycled to the atomic trap for the next propulsion cycle.

Several points of explanation or definition will be useful in understanding the illustrative embodiment of the present invention and its underlying principles.

The term “long range” interaction or force usually describes a force that decays with distance as 1/Rⁿ, where n is a positive number. The term “short range” interaction or force usually describes a force that decays with distance as exp[−R]. Those conventions are not followed in this disclosure. Rather, for the purpose of this disclosure and the appended claims, terms that “short range” and “long range” are comparative or relative terms. For example, the language “inducing the lifting force to exhibit relatively long range interactions” means that the lifting force is induced to exhibit a relatively longer-range interaction than is normally the case.

Since the momentum that is donated by the particles propels the vehicle, there might be a tendency to characterize the particles as “fuel.” But the particles are not “fuel” in any conventional sense of that term. They simply serve as a “momentum exchanging element.”

It is important to recognize that the particles are not accelerated by the wall of the spacecraft but, rather, by their mutual dipole fields (van der Waals force) as distorted by the craft's acceleration (gravitational or otherwise). In other words, this method does not violate the action-reaction law, since the motion of the particles is not due to action of vehicle upon them.

An example of “action of the vehicle” on the particles is if the atoms were accelerated due to an explosion in the trap. In that case, the net of all internal forces on the system would be zero and, at the end of the process, the craft would not gain any momentum. In accordance with the illustrative method, however, the atoms accelerate towards the piston, etc., independently of the vehicle and do transfer a net amount of momentum to it during impact.

The lifting force that is “generated” by the method is not a new force. Rather, it is simply the vertical component of a known intermolecular force; in particular, the van der Waals force. This vertical component arises from an asymmetry in the van der Waals force that results from the introduction of a gravitational field (or acceleration). There would be no such asymmetry, nor vertical component of force, in flat space-time.

This result—that the interaction potential between two neutral atoms in their ground state depends upon the position of the atoms in a gravitational field—is new. Previous studies pertained to the distortion of the field of two point charges, not two dipoles (atoms). While this “new” force is measurable with presently existing technology, harnessing it, such as to lift an object, is not feasible, since this force amounts to an exceedingly small correction to the total weight of each atom.

It is useful to note that using many such atom pairs does not improve this situation, because that does not result in a larger force per atom. The reason for this is that the inter-atomic energy is a function, to a large power, of the reciprocal of distance. In other words, the atom-atom dispersion-force interaction is a realtively short-range force. As a consequence, the total “lifting” force on a large number of atoms is increased only minutely with respect to the lifting force acting on just one pair of atoms. That is, if the number of atoms is N, there will be about N pairs (for N>>1) to consider, but the mass of the system also goes up as N. So, there is no gain realized by adding atoms.

Critical to the present invention is the inventor's recognition that if this newly discovered “effective force” could be transformed from a relatively short-range interaction into a relatively long-range interaction, the lifting force that is available would be greatly increased. In particular, if particles could be made to interact over the long range, then the total energy of the system results from the interaction of every particle with all other particles present. For large groups of particles (N>>1), the interaction grows as N², while the total mass of the system is only growing proportionally to N. As a consequence, a large gain in energy can be realized by using large groups of particles.

A mechanism for transforming relatively short-range interactions into relatively long-range interactions was theoretically discovered several years ago and has been re-evaluated more recently as a way to introduce unusual behaviors in a cloud of trapped atoms. See, Kurizki et al., “New Regimes in Cold Gases Via Laser-Induced Long-Range Interactions,” . . . . The method involves isotropic illumination of atoms by lasers. That technique, with several modifications, is utilized in conjunction with the illustrative embodiment.

As previously noted, the present propulsion system and method overcomes a key drawback of chemical engines; namely, the fact that at some point, the fuel is expended. In accordance with the illustrative embodiment of the present invention, it is possible to maintain acceleration without expelling high-speed gases. In other words, the propulsion system does not require fuel. Alternatively, if the “particles” are considered to be “fuel,” then there is no consumption of fuel due to the process.

As previously mentioned, the illustrative propulsion systems and methods described herein are not energy free. In particular, to achieve the required transformations, an intense radiation field, such as can be generated by powerful lasers, must be developed throughout the region in which the particles are trapped. In the case of a craft destined for extremely long interplanetary or interstellar flights, the energy required to power the lasers is obtained, for example, from an on-board nuclear reactor, akin to the reactors powering some submarines.

The propulsion system described herein has many applications. In particular, in addition to its use as a propulsion system for spacecraft, it can be used to deliver a payload into low earth orbit without requiring orbital speeds. Furthermore, a small version of the propulsion system could be attached to literally any item (e.g., a pallet of goods, a railroad car, etc.) so that the item could be readily moved (e.g., in a warehouse, loaded onto a cargo ship, etc.) as needed. The propulsion system can, of course, also be used in conventional aircraft.

Additionally, the present propulsion system can be used to supplement a main, conventional propulsion system. In fact, this would facilitate phase-in to replace conventional technologies. For example, a propulsion system in accordance with the illustrative embodiment that is not sufficiently powered to bring a craft to a hover could be used to effectively reduce the mass of the craft, thereby improving the fuel consumption of the main propulsion system. Alternatively, it could be used as a supplemental system for emergencies.

### BRIEF DESCRIPTION OF THE DRAWINGS

FIG. 1 depicts distortion in the spherical symmetry of the field of a simple charge, as caused by the presence of a gravitational field.

FIG. 2 depicts distortion in the cylindrical symmetry of the field of a classical dipole, as caused by the presence of a gravitational field.

FIG. 3 depicts a propulsion system in accordance with the illustrative embodiment of the present invention.

FIG. 4 depicts the propulsion system of FIG. 3, wherein lasers are illuminating confined particles.

FIG. 5 depicts the propulsion system of FIG. 3, wherein particles impact against an elastically-bound piston.

FIG. 6 depicts the propulsion system of FIG. 3, wherein particles are pumped back to a reservoir for use in a subsequent propulsion cycle.

FIG. 7 depicts a method in accordance for propulsion in accordance with the illustrative embodiment of the present invention.

FIG. 8 depicts a schematic of a vehicle that incorporates the propulsion system of FIG. 3.

FIG. 9 depicts a schematic of the nuclear power subsystem of the vehicle of FIG. 8.

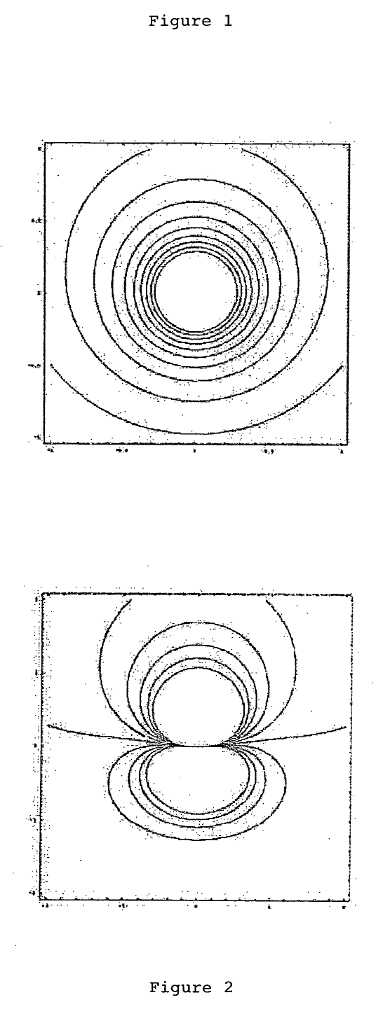

### DETAILED DESCRIPTION

This Detailed Description proceeds with Section 1.1, which provides a description of propulsion system 100 and a method for propulsion in accordance with the illustrative embodiment of the present invention. Section 1.2 discloses a vehicle that incorporates propulsion system 100. The remaining sections, which include Sections 2.1-2.4 and 4 provide a theoretical development for propulsion system 100 and performance estimates.

1.1 Propulsion System 100

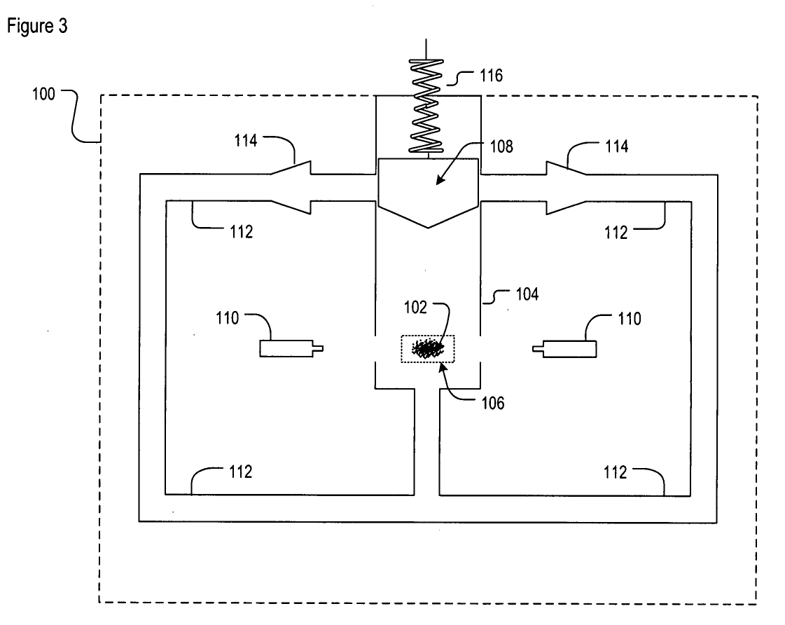

FIG. 3 depicts propulsion system 100 in accordance with the illustrative embodiment of the invention. Propulsion system 100 includes particles 102, chamber 104, piston 108, source(s) of electromagnetic radiation 110, return line(s) 112, and pump(s) 114, interrelated as shown.

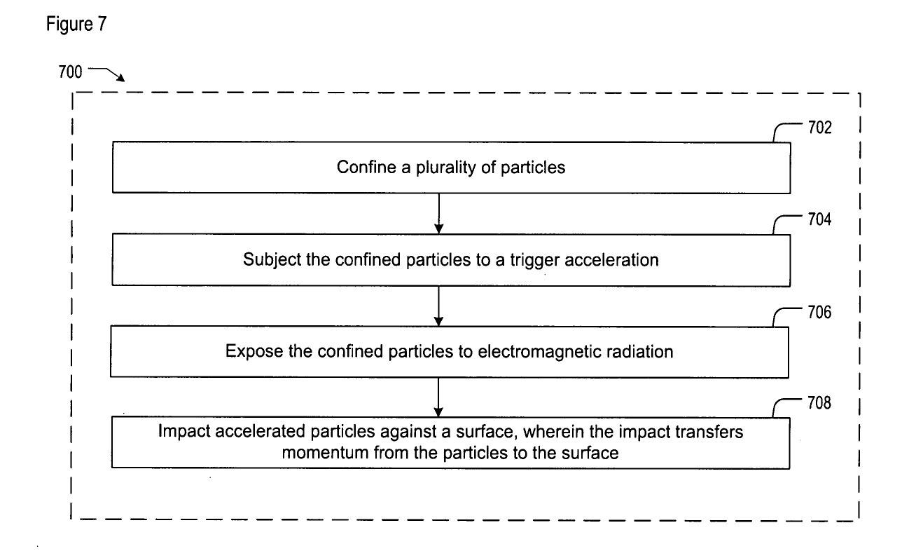

FIG. 7 depicts method 700 for propulsion, which can be used in conjunction with propulsion system 100. In accordance with operation 702 of method 700, a plurality of particles are confined.

FIG. 3 depicts propulsion system 100 at the beginning phase of the propulsion cycle. Particles 102, which in some embodiments are ground-state atoms, are confined in particle trap 106 of chamber 104 in known fashion and in accordance with operation 702.

In operation 704, particles 102 are subjected to a trigger acceleration. This can be accomplished, for example, by supporting propulsion system 100 in a gravitational field. Assuming propulsion system 100 is in a vehicle, such support is provided, for example, if the vehicle is at rest on the surface of the Earth or in flight, as long the vehicle is not in free fall. In some alternative embodiments, the trigger acceleration can be kinematic, such as by rotating the craft, or by using a conventional propulsion system to accelerate the craft.

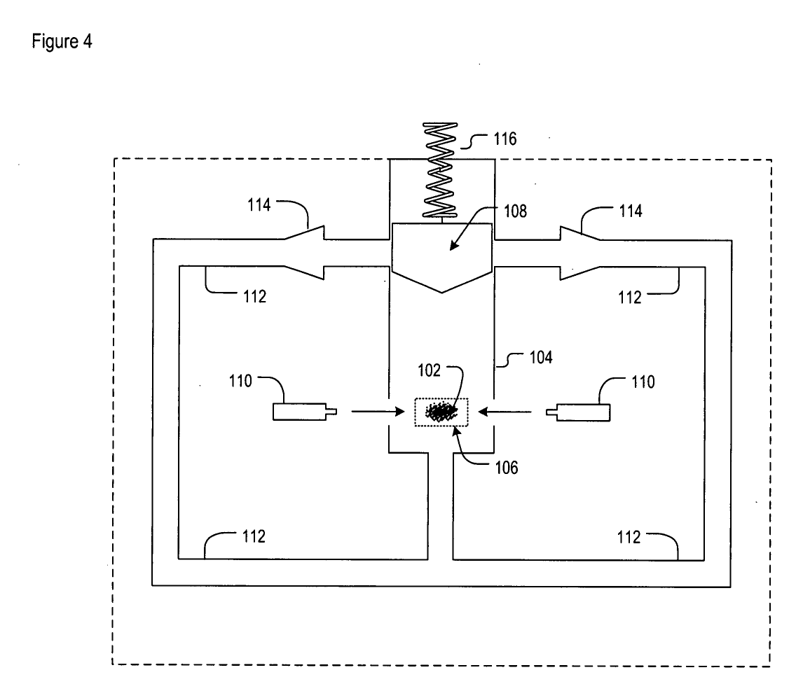

At operation 706, the particles are exposed to an amount of electromagnetic radiation that is sufficient to:
1. induce an effective inter-particle force that arises between said particles to exhibit long-range interactions; and
2. increase the momentum of the particles.
   This operation is depicted in FIG. 4, wherein sources of electromagnetic radiation 110 (“EM sources 110”) are activated and directed toward particles 102. In some embodiments, the EM sources are high-power lasers. In the FIG. 4, two EM sources 110 are shown. Depending upon the power required for a given embodiment, far more EM sources might be required. Power requirements for driving the propulsion system are described in

The EM radiation causes an upward acceleration of particles 102 with respect to a vehicle, etc., that houses propulsion system 100. In the case of an ideal propulsion system, particles 102 remain trapped in place (in particle trap 106) as they mutually interact and the craft is accelerated upward by the reaction of the atoms themselves against whatever forces are used to keep them in trap 106.

It is possible, if not likely, that once particles 102 are accelerated by conducting operations 704 and 706, they will escape from particle trap 106. This is a non-ideal situation, which yields less than the ideal momentum. But, if particles are allowed to escape, this relaxes the constraints on particle traps 106. That is, suitable traps can be readily constructed with existing technologies. See, e.g., H. J. Metcalf and P. van der Straten, Laser Cooling and Trapping (Springer, N.Y., 1999); http://ww.rle.mit.edu/cua/research/project 02/project 02.vandp.htm. These references describe techniques for trapping atoms at extremely low temperatures.

Although it is necessary for the generation of the lifting force itself, it is desirable to trap particles at very low temperatures because the thermal speed of, for example, atoms, even at room temperature, is comparable to the maximum speeds that can be obtained by this method. It is, therefore, “easier” to illuminate the atoms for an appropriate length of time if they are not moving at very high thermal speeds.

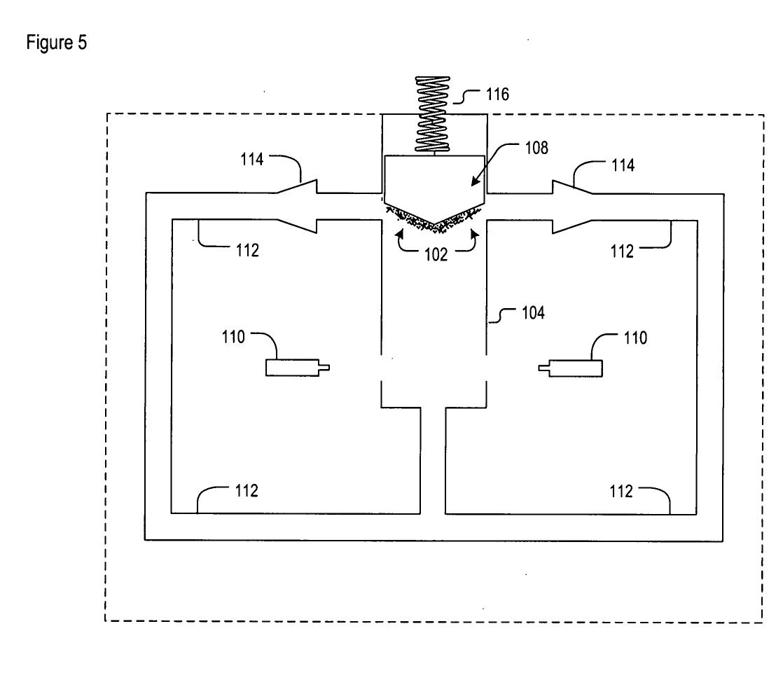

Continuing with the description of method 700, operation 708 recites impacting the accelerated particles against a surface, thereby transferring some of the momentum of the particles to the surface. This operation is depicted in FIG. 5, wherein particles 102 impact piston 108 at high speed.

Piston 108 functions as a shock absorber. That is, the piston provides an area against which particles 102 can impact and which can transfer momentum to the vehicle non-destructively at every forward stroke. In propulsion system 300, non-destructive momentum transfer is indicated by spring 116, which elastically couples piston 108 to a vehicle. Shock absorber technology for aerospace applications is well developed within the context of pyrotechnic release technology. See, e.g., N. Butterfield, Pyrotechnic Release Devices, in Space Vehicle Mechanisms, P. Conley, Ed. (Wiley, N.Y., 1998).

As illustrated in FIG. 5, in propulsion system 100, as piston 108 moves upward, return lines 112 are accessed. The return lines provide a route back to particle trap 106. As particles move away from piston 108, the piston drops back to a seated position against chamber 104.

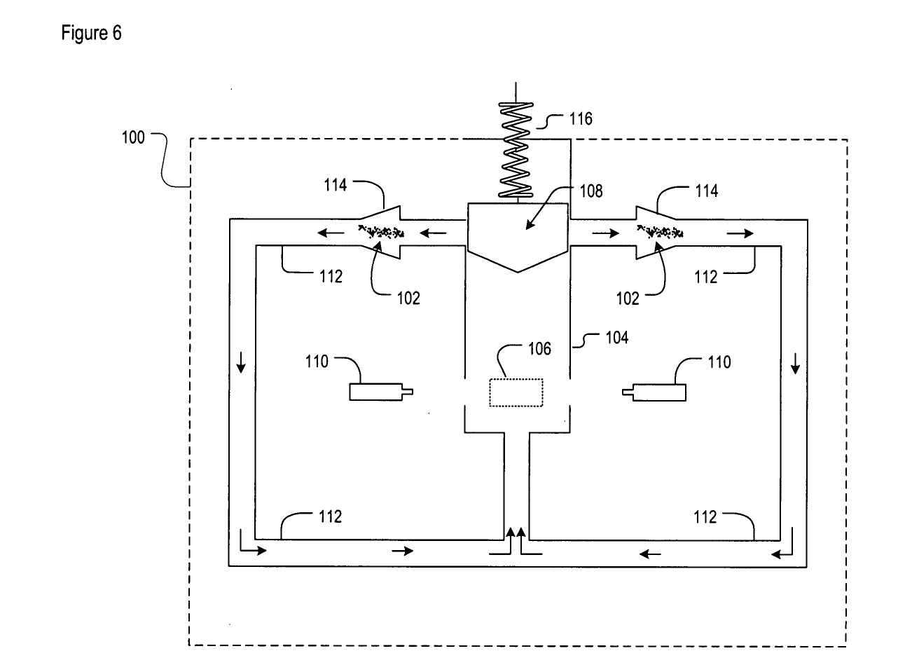

FIG. 6 depicts particles 102 in return lines 112, being pumped via pumps 114 toward a gas reservoir (not depicted) for reuse in a subsequent propulsion cycle. The propulsion cycles occur at a rapid and substantially continuous pace.

It is very important to recognize that in propulsion system 100, and in accordance with method 700, particles 102 are NOT being accelerated by the walls of the vehicle or by the chamber in which they reside. Rather, they are accelerated by their mutual dipole fields, as distorted by vehicle acceleration (i.e., gravitational or otherwise). There is, therefore, no concern that this scheme violates the action-reaction law, since the motion of particles 102 is NOT due to an action upon them by the vehicle.

An example of a situation in which the walls of the vehicle are acting on particles 102 is if the particles were accelerated by an explosion in chamber 104. In such a case, the net sum of all internal forces on the system would be zero and, at the end of the process, the vehicle would not gain any net momentum. But using the methods and apparatus described herein, particles 102 are accelerated toward piston 108 INDEPENDENTLY of the vehicle and, on impact, transfer a net amount of momentum to it.

1.2 Vehicle Incorporating Propulsion System 100

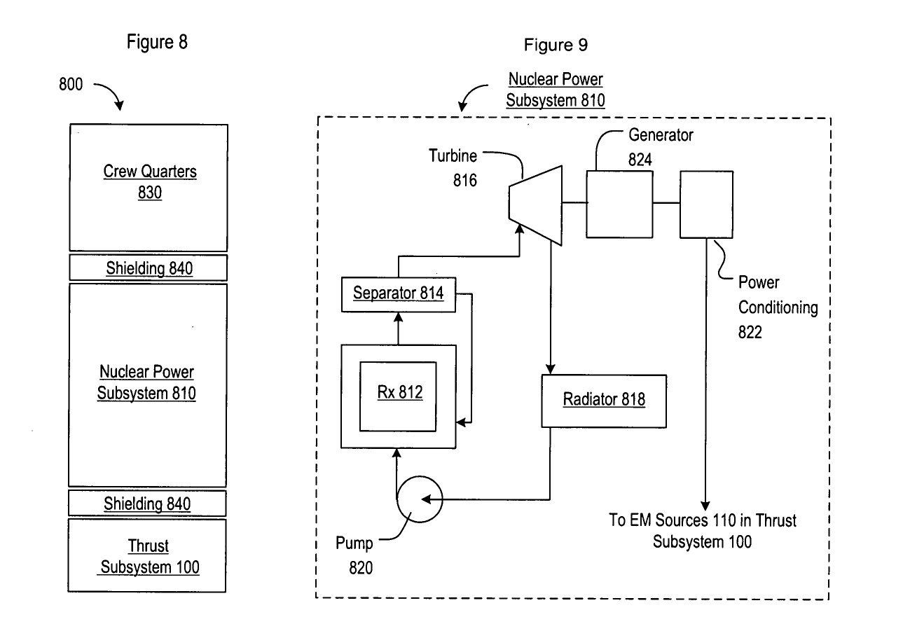

FIG. 8 depicts vehicle 800, which incorporates propulsion system 100 in accordance with the illustrative embodiment of the present invention. As depicted in FIG. 8, vehicle 800 includes propulsion subsystem 100, nuclear power subsystem 810, crew quarters 830, and shielding 840, arranged as shown.

The presence of nuclear power subsystem 810 requires the use of shielding 840 to protect crew quarters 830 and propulsion subsystem 100. Those skilled in the art will be capable of designing and building shielding suitable for this purpose.

The purpose for nuclear power subsystem 810 is to generate electricity to power EM source(s) 110. Nuclear power is used as a power source due to the ability of a nuclear reactor to provide continuous power for extended periods of time (e.g., several years, etc.). Operation of nuclear power subsystem 810 is described in more detail below in conjunction with FIG. 9.

Propulsion subsystem 100 couples to shielding 840, which receives momentum transferred from piston 108 (see FIGS. 3-7 and the accompanying description). This substantially continuous transfer of momentum from particles 102 to piston 108 to vehicle 800 (e.g., shielding 840) drives the vehicle.

In the embodiment that is depicted in FIG. 8, propulsion subsystem 100 is disposed an end of vehicle 800. This location draws maximum advantage from a rotational trigger acceleration while providing the crew, in crew quarters 830, with appropriate gravity-like conditions.

FIG. 9 depicts an embodiment of nuclear subsystem 810 suitable for use to provide electricity to drive EM sources 110 (e.g., lasers, etc.) in propulsion subsystem 100. The embodiment that is depicted in FIG. 9 is a direct Rankine cycle continuous power system. (See, e.g., M. W. Edenburn, “Models for Multimegawatt Space Power Systems,” Sandia Report SAND86-2742 (June 1990). This type of system is suitable for use with vehicle 800 due to its ability to provide continuous power for several years.

Nuclear subsystem 810 includes nuclear reactor 812, separator 814, turbine 816, radiator 818, pump 820, generator 822, and power conditioning unit 824.

Reactor 812, which is liquid metal cooled, boils potassium and sends the saturate vapor to turbine 816 for power generation. Since the fluid leaving the “hot” end of reactor 812 is unlikely to be pure vapor, separator 814 is used to separate the saturated vapor from its accompanying liquid. The liquid is recirculated to the “cold” end of reactor 812.

Waste heat is rejected by space radiator 818. Since the system rejects heat from a condensing working fluid, the radiator operates nearly isothermally and radiates a relatively large amount of heat per unit area. Condensed liquid is returned to the “cold” end of reactor 812 via pump 820.

Electricity that is produced by generator 822 is appropriately conditioned in power conditioning unit 822 to provide EM sources 110 with a suitable supply of electrical power.

2.1 Distorted Dipole-Dipole Potential

It is already a well-known fact that a gravitational field can introduce novel forces acting on a single charge or on a dipole. An example is the self-interaction of a point charge in a Schwarzschild geometry [8], ultimately due to the term Linet [9] discovered has to be added to the Copson potential [10] in order to satisfy the appropriate asymptotic boundary conditions for this problem. Commenting about the very extreme conditions nearby a miniblack-hole, Smith and Will wrote that “[I]t is amusing to note that . . . the test particle's electrostatic self-force would suffice to support it against the hole's gravity, without the help of any external force.”

Unfortunately, however, such fascinating conclusion is undermined by the fact that, as pointed out by these authors, “it is meaningless to talk of an electron being held fixed at, say, 10⁻¹³ cm from a miniblack hole, when the Compton wavelength of an electron is two orders of magnitude larger than this.” Following this approach, the self-interaction of a static dipole has also been calculated [11], but Parker has shown that this force has no effect on the Hamiltonian of a neutral atom in free-fall [12].

Another example is the “electrostatic levitation of a dipole,” predicted on the basis of the distortion caused by a uniform gravitational field [13]. This author found that “one is unlikely to witness such levitation,” which could only be observed in a fixed classical dipole whose electron charge separation is 1.4×10⁻¹⁵ m. The outlook for detection of these field distortion phenomena was effectively summarized by Boyer, who stated that “Clearly our example may be instructive from a theoretical point of view, but it does not lend itself to easy experimental measurement.”[14]

In this section, we consider the effect of a weak gravitational field upon intermolecular forces. In particular, the effect of gravitation on the van der Waals hydrogenic interatomic potential in the unretarded regime is discussed within non-relativistic first-order perturbation theory. The quantitative conclusion of these computations is that the system proposed herein shows extreme promise for direct experimental verification although the effect is certainly too small to be of any practical engineering use in the field of propulsion.

The first step to obtain the distorted dipole-dipole potential is the calculation of the electrostatic potential, and thus of the electric field, of a point dipole in the presence of gravitation. For this purpose, let us start by considering the potential field of a single point charge q located at a position r₀=x₀ⁱ in the quasi-homogeneous gravitational field caused by a relatively distant spherically symmetrical mass distribution M located at a radial distance R from the dipole. This has been the subject of several investigations, starting with the pioneering work of Whittaker [15].

Since we are considering a charge in a gravitational field g antiparallel to the z-axis and located at a position other than the origin, we transform the unprimed Rindler coordinates defined by the usual metric

$$d {s}^{2} = {( 1 + \frac{gz}{{c}^{2}} )}^{2} {c}^{2} d {t}^{2} - ( d {x}^{2} + d {y}^{2} + d {z}^{2} ) , \qquad ( 1 )$$

by introducing new primed coordinates given by t=(1+gz₀/c²)⁻¹t′, xⁱ=x₀ⁱ+x′ⁱ. By substituting these definitions into Eq. (1), it is simple to show that the metric in the new coordinates is:

$$d {s}^{2} = {( 1 + \frac{{G}_{R} {z}^{′}}{{c}^{2}} )}^{2} {c}^{2} d {t}^{′ 2} - ( d {x}^{′ 2} + d {y}^{′ 2} + d {z}^{′ 2} ) , \qquad ( 2 )$$

where G_{R}≡g/(1+gz₀/c²). With this result, we can transform Whittaker's expression for the electrostatic potential in Kottler-Whittaker coordinates into our transformed Rindler frame (for simplicity of notation, we neglect to write the primes in what follows):

$$V ( r ; {r}_{0} ) = \frac{q}{\vert r - {r}_{0} \vert} \frac{[ 1 + \frac{g ( z + {z}_{0} )}{{c}^{2}} + \frac{{g}^{2}}{2 {c}^{4}} ( {\vert ρ - {ρ}_{0} \vert}^{2} + ( {z}^{2} + {z}_{0}^{2} ) ]}{( 1 + \frac{g {z}_{0}}{{c}^{2}} ) \sqrt{1 + \frac{g}{{c}^{2}} ( z + {z}_{0} ) + \frac{{g}^{2}}{4 {c}^{4}} {\vert r - {r}_{0} \vert}^{4}}} \qquad ( 3 )$$

where |r−r₀|²=(x−x₀)²+(y−y₀)²+(z−z₀)², |ρ−ρ₀|²=(x−x₀)²+(y−y₀)². This expression of course approaches the Coulomb potential as gxⁱ/c², gx₀ⁱ/c²→0. In this paper, we shall neglect the Linet term [9] responsible for the self-interaction discussed above since this contribution will be shown to be negligible with respect to the effects treated herein.

In order to write down the electrostatic dipole field in the presence of a gravitational field, we use the formulation of Léauté and Linet, originally designed to calculate the self-interaction of an electric dipole [11]. For a point dipole A of moment d_{A}=d_{A}ⁱ, with k=1 . . . 3, located at r_{A}, the result found by these authors, neglecting the self-interaction term [12], can be written as:

$${U}_{dip , W} ( {x}^{k} , {x}_{A}^{k} ) = {d}_{A}^{i} \frac{\partial {V}_{C} ( {x}^{k} , {x}_{0}^{k} )}{\partial {x}_{0}^{i}} {\vert}_{{r}_{A}} , \qquad ( 4 )$$

where V_{C} is the Copson potential, which, in the quasi-homogeneous field limit, coincides with our solution above.

Since, to the best of this author's knowledge, this potential has never been graphically represented, it is shown, along with the corresponding electric field lines, in FIG. 3 for a point dipole d_{A}ⁱ=d_{A}k.

By computing the electric field as usual, after some very lengthy algebra [13] one obtains the general expression for the interaction potential energy W_{dd}(r, r₀; d_{A}ⁱ, d_{B}ⁱ) of two point dipoles of moments d_{A}ⁱ and d_{B}ⁱ, placed at positions r₀ and r, respectively. In order to illustrate the physical meaning of this result, let us write it to second order in gR/c² for the case of dipole A placed at the origin and dipole B placed at r=(R, 0, 0):

$${W}_{dd} \approx \frac{{q}^{2}}{{R}^{3}} [ ( {x}_{A} {x}_{B} + {y}_{A} {y}_{B} - 2 {z}_{A} {z}_{B} ) + \frac{1}{2} ( \frac{g R}{{c}^{2}} ) ( 1 - \frac{g R}{{c}^{2}} ) ( {x}_{A} {x}_{B} + {y}_{A} {y}_{B} ) ] , \qquad ( 5 )$$

which again yields the usual Minkowski space result [17] if the gravitational field is absent. Interestingly, the asymmetry due to the presence of the gravitational field causes a net vertical force upon each dipole in this geometry where there would of course be none in flat space-time. For instance, in the case of two antiparallel dipoles d_{A}ⁱ=−d_{B}ⁱ=d_{A}k, we find that this force F_{dd}=−∂W_{dd}/∂z is, again to second order:

$${F}_{dd , z} = \frac{3}{2} \frac{{q}^{2}}{{R}^{3}} \frac{g}{{c}^{2}} {z}_{A}^{2} , \qquad ( 6 )$$

which is the dipole-dipole analogy of the levitation force upon a single dipole mentioned at the beginning of this section [15].

The problem of a single hydrogenic atom either held fixed or in free-fall within various assigned metrics has been discussed extensively by starting from generally covariant expressions of the Dirac equation in curved space-time [18]. The present author has discussed realistic astrophysical settings for the observation of the perturbative effects of gravitational fields on freely-falling atoms both in the static case and within the framework of possible remote gravitational wave detection [19].

Tourrenc and Grossiord, in their treatment of a hydrogen atom held fixed in a Schwarzschild geometry, have shown that the most significant contribution to the perturbative Hamiltonian by far derives from what can be interpreted as the classical weight of the electron in the gravitational field. However, since the corresponding energy shift for a ground-state atom is found to be ΔE˜2(GMmₑ/R²)a₀≈6×10⁻²¹ eV, we shall neglect it here and use the unperturbed hydrogenic wavefunctions to evaluate the interatomic gravitational self-force.

As in the undistorted van der Waals case, the general expression for the potential W_{dd}(r, r₀; d_{A}ⁱ, d_{B}ⁱ) contains only bilinear forms of the type x_{A}ⁱx_{B}^{j} and thus yields no first-order contribution in the case of symmetrical hydrogenic nS. The second order correction on the other hand is [20]:

$$Δ {E}_{vdW}^{( 2 )} = {\sum }^{′} \frac{{\vert 〈 {ϕ}_{n , l , m}^{A} ; {ϕ}_{{n}^{′} , {l}^{′} , {m}^{′}}^{B} \vert {W}_{dd} ( r , {r}_{0} ; {d}_{A}^{i} , {d}_{B}^{i} ) \vert {ϕ}_{1 , 0 , 0}^{A} ; {ϕ}_{1 , 0 , 0}^{B} 〉 \vert}^{2}}{- 2 {E}_{I} - {E}_{n} - {E}_{{n}^{′}}} , \qquad ( 7 )$$

where |φ_{n,l,m}^{A}> are the unperturbed eigenfunctions of energy Eₙ, the total energy of the unperturbed atomic pair is −2E_{I}, and the primed summation indicates that the |φ_{1,0,0}^{A}; φ_{1,0,0}^{B}> term is excluded.

By inspecting Eq. (5), it is evident that, in the gravitational case, the second order intermolecular potential, to second order in gxⁱ/c², takes on the general form:

$$Δ {E}_{vdW}^{( 2 )} = \frac{{C}_{0}}{{R}^{6}} + ( \frac{g}{{c}^{2}} ) \frac{{C}_{1}}{{R}^{5}} + {( \frac{g}{{c}^{2}} )}^{2} \frac{{C}_{2}}{{R}^{4}} , \qquad ( 8 )$$

where C₀, C₁, and C₂ are appropriate dimensional constants, which in principle depend on the variables r, r₀, d_{A}ⁱ, and d_{B}ⁱ. For instance, again in the geometry used in the examples above, one can quickly recover the well-known result that C₀≈−6e²a₀⁵ as well as show that C₁≈−2e²a₀⁵, and

$${C}_{2} \approx + \frac{3}{2} {e}^{2} {a}_{0}^{5} ,$$

where a₀ is the Bohr radius.

In our case, however, we are not here interested in the modification of the intermolecular forces due to the presence of gravitation, but rather we want to pursue isolating the vertical component of the gravitational self-force due to the dipole-dipole interaction of two hydrogenic atoms in the |1,0,0>eigenstate located at r₀=0 and r=(R, 0, 0), respectively:

$$\begin{matrix}{F}_{sf , z}^{( 2 )} = - \frac{\partial }{\partial z} Δ {E}_{vdW}^{( 2 )} \\ \approx - \frac{{\vert 〈 {ϕ}_{1 , 0 , 0}^{A} ; {ϕ}_{1 , 0 , 0}^{B} \vert \frac{\partial }{\partial z} {W}_{dd} ( r , {r}_{0} ; {d}_{A}^{i} , {d}_{B}^{i} ) \vert {ϕ}_{1 , 0 , 0}^{A} ; {ϕ}_{1 , 0 , 0}^{B} 〉 \vert}^{2}}{- 2 {E}_{I}} ,\end{matrix} \qquad ( 9 )$$

Explicit evaluation [13] yields the following result to first order in gxⁱ/c²:

$${F}_{sf , z}^{( 2 )} \approx \frac{{e}^{4}}{2 {E}_{I} {R}^{6}} \frac{g}{{c}^{2}} 〈 {ϕ}_{1 , 0 , 0}^{A} ; {ϕ}_{1 , 0 , 0}^{B} \vert ( 4 {x}_{A}^{2} {x}_{B}^{2} - 4 {x}_{A} {x}_{B} {y}_{A} {y}_{B} + {y}_{A}^{2} {y}_{B}^{2} - 3 {z}_{A}^{2} {x}_{B}^{2} - 14 {x}_{A} {x}_{B} {z}_{A} {z}_{B} + 4 {y}_{A} {y}_{B} {z}_{A} {z}_{B} - 3 {x}_{A}^{2} {z}_{B}^{2} + 3 {z}_{A}^{2} {z}_{B}^{2} ) \vert {ϕ}_{1 , 0 , 0}^{A} ; {ϕ}_{1 , 0 , 0}^{B} 〉 . \qquad ( 10 )$$

By again making use of the fact that the cross terms vanish in the 1s state and that <φ_{1,0,0}^{A}|x_{A}²|φ_{1,0,0}^{A}>=<φ_{1,0,0}^{A}|⅓r_{A}²|φ_{1,0,0}^{A}> and equally for all the other squared terms, we finally find:

$$\begin{matrix}{F}_{sf , z}^{( 2 )} \approx + \frac{{e}^{4}}{2 {E}_{I} {R}^{6}} \frac{g}{{c}^{2}} \times 2 {\vert 〈 {ϕ}_{1 , 0 , 0}^{A} \vert \frac{1}{3} {r}_{A}^{2} \vert {ϕ}_{1 , 0 , 0}^{A} 〉 \vert}^{2} \\ = + 2 \frac{{e}^{2} {a}_{0}^{5}}{{R}^{6}} \frac{g}{{c}^{2}} \\ = + \frac{1}{16} ℏ {ω}_{0} \frac{{α}_{0}^{2}}{{R}^{6}} \frac{g}{{c}^{2}} ,\end{matrix} \qquad ( 11 )$$

where the last equality was obtained by writing the ionization energy and the polarizability as E_{I}=e²/2a₀ and α₀=(2a₀)³, respectively. Notice that this result does not coincide with what one might expect from näively calculating one half of the negative contribution to the gravitational mass of the London binding energy of the pair, since in that case the coefficient would be ⅜ and not 1/16.

An explicit estimate of this result in the case of two hydrogen atoms in their ground state at, for instance, 20 a₀, yields a relative acceleration a_{lift,H}˜4×10⁻¹³ cm/s². The situation improves dramatically if one considers two positronium (Ps) atoms, in which case we find a_{lift,Ps}˜8×10⁻¹⁰ cm/s², which is in principle detectable via atomic interferometry, at the price of dealing with the added complications of interferometry of atoms with a finite lifetime.

2.2 Relevance of the Above Results

The above results show that the distortion of the classical dipole-dipole field caused by gravity results in a net force upon each dipole, which is anti-parallel to the weight of each atom. This phenomenon has been known for some time, although its implications at the quantum level have not been fully explored and engineering implications do not appear to have attracted their due attention. Interestingly, the warping of the Coulomb field due to gravitation renders their mutual interaction non-central, which in turn implies that Newton's action-reaction law will not be satisfied by this system. Although there is no study of this exotic problem in the literature, it is clear that, if the problem were to be considered from the standpoint of full quantum electrodynamics (QED), it would result that the virtual photon field responsible for the charge-charge interaction is perturbed by the gravitational acceleration so as to carry a net momentum flux, part of which is simply transferred to the dipole, or dipoles, thus resulting in their upward motion.

Importantly, this phenomenon makes the interaction energy between two hydrogen atoms in their ground state dependent upon their position within the gravitational field, which results in a force upon the pair even in the quantum case. The existence of this additional force acting on an atomic pair is by itself a new result, since previous studies had concentrated on the distortion of the field of two point charges, and not of two dipoles. Despite the fact that this new and additional force is measurable with presently existing technology, its use in an actual lifting device is unlikely, since it amounts to a very small correction of the total weight of each atom.

The important consideration, critical to the present invention, is that adding many atomic pairs does not result in a larger force per atom. The reason for this is that the interatomic energy is a function of a large power of the reciprocal of the distance—which results in the atom-atom dispersion interaction being a short-range force. Therefore, the total lifting force on a large number of atoms is increased only very slightly with respect to that acting on just one pair. Therefore, if the number of atoms is N, there will be ˜N pairs to consider but the mass of the of the system also went up as N. Thus no gain is made.

The critical, and non-obvious, point of the present invention is to transform the new force outlined above from a short-range force into a long-range force, as we consider in the next section. In principle, if point-like particles interact via a long-range force, the total energy of the system results form the interaction of every atom with all the others, something which is not possible in the short-range. For instance, if a system is made up of three particles, the total energy will result from the interaction of particle 1 with 2, particle 1 with 3, and particle 2 with 3. However, if the number of particle is now ten, we will have to consider the interaction of particle 1 with 2, 3 . . . , 10, and so fort, which results, in the case of a large number of particles. For large N (N>>1), in this case the number of interaction grows as N², while the total mass of the system is still only growing proportionally to N.

This point would only be of philosophical importance if we did not have available a mechanism to indeed transform atom-atom interactions from short-range into long-range. Such mechanism was discovered theoretically several years ago and has been reproposed recently as a way to introduce unusual behaviors in a cloud of trapped atoms. Atomic traps have become one of the hottest subjects of scientific research in recent years. The method proposed by the researchers to cause the atom-atom interaction to become a long-range force can of course also be used in our case to leverage the presence of a large number of atoms so as to make the lifting force due to the gravitational distortion we have seen above much larger by many orders of magnitude. The technological price to pay is that, in order for this transformation to occur, powerful lasers must be pumping an intense radiation field throughout the region where the atoms are trapped.

2.3 Trapped Gases in Curved Space-Time: the Effect of Radiation Fields

It is well-known that an intense directional radiation field, such as that produced by a laser, alters the nature of intermolecular forces [21]. For instance, in the near zone region, where k_{L}R <<1 and k_{L} is the laser light wavenumber, the power dependence of the force becomes ≡−1/R³. Importantly, if a molecular pair is allowed to “tumble” with equal probability in all directions with respect to the radiation field, the unretarded force averages out and the only term left is that due to the retarded part of the Hamiltonian. The resulting contribution, which can be produced by appropriate laser beams [22] and is still attractive, is [21]:

$$\begin{matrix}Δ E ≃ - \frac{44}{15} ( \frac{I π {k}_{L}^{2}}{c} ) \frac{{α}^{A} ( {k}_{L} ) {α}^{B} ( {k}_{L} )}{R} , & {k}_{L} R ⪡ 1 ,\end{matrix} \qquad ( 12 )$$

where a α^{A, B}(k_{L}) are the dynamic polarizabilities of the two atoms, I is the intensity of the beams, and the domain of validity of this result is everywhere in space except where the atom-atom exchange interactions become important. It is simple to see numerically that this energy is much smaller than the usual van der Waals force at near range but, as originally pointed out by Thirunamachandran [21], the long-range nature of the force offers the potential to actually achieve remarkable effects.

Let us now consider the distortion of Thirunamachandran's long-range interaction due to an external gravitational field, such as that present in a ground-based laboratory. One is fully justified by both our results in the unretarded case and by dimensional considerations to assume that a molecular pair interacting through the gravity-like attractive long-range force at Eq. (12) will also undergo a lifting force of the type:

$${F}_{lift , z}^{AB} ∼ ( \frac{I {k}_{L}^{2}}{c} ) \frac{{α}^{4} ( {k}_{L} ) {α}^{B} ( {k}_{L} )}{R} \frac{g}{{c}^{2}} . \qquad ( 13 )$$

For the purpose of order of magnitude estimation, let us write the total potential energy of N atoms contained in a spherical volume of diameter D interacting through a mean field determined by Eq. (12) simply as U_{gas}˜−N²(Ik_{L}²/c)α^{A}(k_{L})α^{B}(k_{L})/D. Therefore, the total lifting force acting upon the center-of-mass of the trapped gas is F_{lift,z}^{gas}˜N²F_{lift,z}^{AB}, assuming all atoms to be of species A, and the corresponding acceleration is:

$$\begin{matrix}\frac{{a}_{lift , z}^{gas}}{g} = \frac{{F}_{lift , z}^{gas}}{N {m}_{A} g} \\ = N ( \frac{I {k}_{L}^{2}}{c} ) \frac{{[ {α}^{A} ( {k}_{L} ) ]}^{2}}{D} \frac{1}{{m}_{A} {c}^{2}} .\end{matrix} \qquad ( 14 )$$

The relevant figures of merit to judge the feasibility to bring such an atomic cluster to a hover are the number of atoms in the trap and its size, the intensity and wavelength of the laser light, and the average intermolecular distance. Consider N=10² atoms in a trap with D≈2×10⁻⁷ cm, which yields an intermolecular distance \overline{R}˜D/N^{1/3}≈10a₀. Now let us have 18 (six triads [22]) high-power lasers each outputting 2.5 kW into a 0.5 cm diameter beam at a wavelength λ_{L}≈1000 Å. Appropriately focused onto the trap size, this would yield an intensity I≈1.3×10¹⁷ W/cm². By moderate off-resonance detuning, it is possible to obtain dramatic increases in atomic polarizability over its static value [23] (another approach may consist of using a cold gas of highly excited Rydberg atoms, since, in this case, the polarizability is proportional to n⁷, where n is the principal quantum number). By adopting α^{A}(k_{L})≈3×10⁵α₀, and by substituting the above numerical values into Eq. (14) in c.g.s. units, we find a_{lift,z}^{gas}/g≈1.5, that is, the system will hover unsupported in the gravitational field of the earth or accelerate upward.
2.4 Relevance of the Above Results

The mechanism outlined above represents the first novel and realistic proposal to achieve lift in the history of flight since the great inventions of the airplane and of the rocket in the 20th century. As we shall see in the detailed numerical estimates below, more atoms than just 10² must be present in the trap for this mechanism to be technologically convenient, although it is possible to trade off a higher laser power for a lower number of atoms in the trap. What is important to stress at this time is that this mechanism represents a non-obvious use of well understood quantum laws in the presence of gravitation for the purpose of creating fuel-free propulsion. Of course fuel-free propulsion does not imply energy-free propulsion. In other words, a source of energy is still needed to achieve the needed thrust. In the case of extremely long interplanetary and interstellar flights it is expected that on-board nuclear energy production will continue to grow in engineering importance, given the fact that no other source has been able to achieve similarly convenient power outputs.

The above invention, however, removes the greatest problem in the way of achieving fuel-free propulsion, that is, the fact that, independently of the energy source used, at some point the fuel available on board is exhausted. For instance, if one could power a spacecraft so as to achieve a constant acceleration of 1 g, the trip from Earth to Mars would require approximately 2-4 days. Although the acceleration of 1 g is smaller than the larger accelerations achievable by present-day rocket technologies, it is absolutely impossible to maintain those accelerations for times longer than minutes at the most, simply because of quick fuel exhaustion. With the scheme outlined in this invention, on the other hand, it is possible to maintain the needed acceleration without any need to expel high speed gases, provided that the required laser illumination is constantly at work transforming the atom-atom interactions from short-range into long-range ones.

It is important to stress another characteristic of the propulsive method of this invention. All the calculations carried out so far imply that the atoms are “at rest,” that is, not in “free-fall.” This is extremely important, since it is only if the atoms are somehow supported by an external force against the gravitational field that a relative acceleration due to that field can affect their mutual interactions. Such is not the case if the atoms are freely falling. In that case, in fact, the acceleration felt by a freely falling object is rigorously zero, because of the Principle of Equivalence at the foundation of the General Relativity theory. To use a well-known popular example, if two atoms are at rest with respect to the walls of a freely falling elevator, they will not feel the presence of any gravitational field—the acceleration of the elevator exactly cancels exactly the gravitational acceleration. In other words, locally, there is no distortion of the dipole-dipole field and thus no change to the van der Waals force (see below for further subtle clarifications on this point).

The Principle of Equivalence can be stated by saying that, locally, there exists no experiment that can indicate the difference between the acceleration due to the presence of a gravitational field and that due to the kinematics of the system. For instance, once could simulate the presence of a gravitational field in the same elevator travelling through outer space by simply accelerating it “upwards” at the same rate as the free-fall acceleration it would have in the gravitational field to simulate. In fact, our Eq. (1) above was obtained exactly by making this assumption. Therefore, the atoms will undergo the lifting force at the basis of this invention whether or not there is a gravitational field against which to lift—their behavior is due to their being within an accelerated reference frame no matter what the reason for the existence of such frame.

In principle, this represents an operational limitation of the present invention, in the sense that, if a spacecraft were to be left to freely-fall in the gravitational field of a massive body, the lifting mechanism would not be operating. For this purpose, the vehicle must be provided with an initial acceleration through other means in order for the thrust cycle described below to commence. For instance, this happens if the craft is at ground level initially, or somehow hovering under the action of an external force. Once the cycle starts, it is only necessary to coordinate the laser illumination of the (n+1)-th cycle to occur during the transfer of momentum due to the atoms that were accelerated during the n-th cycle. The dipole-dipole field during that time will behave as though under the effect of a gravitational field of that acceleration, because of the Principle of Equivalence.

From the practical standpoint, it is appropriate to stress that every propulsive or lifting system has an appropriate envelope of performance which, is exceeded or not met, will result in insufficient or abnormal behavior. For instance, the lifting force due to the wings of an airplane will cease to be effective if the airflow detaches from the wings because of a stall condition. Therefore, pilots are trained to operate so as to remain well clear of the conditions that might lead to a stall of the airfoils, such as, for instance, excessively low speed for a fixed wing aircraft. Similarly, it is expected that the propulsive system of this invention, in its simplest embodiment, must be operated under appropriate conditions of initial acceleration, in both magnitude and direction. This is much less complicated than it may appear. For instance, in outer space, an initial acceleration can be imparted by causing the entire spacecraft to rotate around an axis by means of a reaction wheel. Once the entire vehicle is rotating like a rigid disk, from the standpoint of the atoms in the propulsive subsystem the rotational acceleration will be indistinguishable from that caused by gravity. Once the thrust cycle is successfully started, the spacecraft can then be despun while the engine provides its own acceleration. In a fixed wing application, it might be possible to make use of the lift provided by the wings themselves in order to start the process.

Finally, it is also important to stress that the Principle of Equivalence only rigorously applies to a volume of space that is infinitely small. Therefore, there exists some distortion of the dipole-dipole field even in the case of freely-falling atoms, although this distortion is far smaller than that of supported atoms, in the sense described above. The effects of this distortion were studied by this author in several papers (see for instance [19]) and it is therefore possible that lift might be obtained in some embodiments even if the craft is initially in free-fall.

4. Performance

Estimating the performance of an aerospace propulsion system based upon entirely novel physical principles naturally presents some difficulties. For instance, the typical concept of specific impulse [29] is undefined in the case in which thrust is obtained without the ejection of high speed gases. At the same time, since the approach calls for the use of high power lasers to engineer the atom-atom interactions into a long-range force, it is of interest to determine whether the thrust thus obtained is in fact larger than that which would be obtained if the laser power utilized were, for instance, projected from the spacecraft into a particular direction in space or whether a laser beam of the same power were to be aimed at a hypothetical laser sail on the spacecraft [3]. In the following subsections we obtain some important order of magnitude estimates both in equation and in graphic form of a few important quantities in order to gain a more realistic understanding of the potential capabilities of a vehicle propelled by means of the physical principle of the present invention.

The conclusions below will clearly establish that the propulsion concept of this invention offers great potential from the standpoint of realistic engineering applications, although such parameters as the exact laser wavelength and power, trap size, atomic mass, and number of atoms of course will have to be optimized according to both accurate theoretical modeling and prototype testing.

In what follows, in order to make a firm connection between the theoretical treatment, which was developed here in the c.g.s. system (centimeter-gram-second), and the more typical engineering M.K.S. units (meter-kilogram-second), the cgs or MKS subscripts will be appended as appropriate. If no subscript is used, the quantity should be assumed as expressed in the cgs system. No use is made if English units throughout (such as, for instance, lbf for thrust). Also, for improved legibility, all order of magnitude signs will be replaced by equal signs.

4.1 Fundamental Equations

4.1.1 Atomic Physics of Trapped Atoms in the Accelerated Propulsive System

Let us consider a gas of N_{A} identical atoms of mass m_{A}, polarizability α_{A}²(k_{L}), confined within an appropriate trap of such dimensions as to correspond to an average interatomic distance \overline{R}. In what follows, we shall assume that the number of atoms, N_{A}, the size of the trap, D, and the average interatomic distance, \overline{R}, are related simply as D˜\overline{R}N_{A}^{1/3}. In addition, Thirunamachandran's theory of dispersion forces under the effect of illumination also requires the constraint that λ_{L}>>\overline{R} [21].

The polarizability α_{A}²(k_{L}) can be made several orders of magnitude larger than its static value, α₀=(2a₀)³, where Bohr's radius is a₀=ℏ²/μₑe² and μₑ is the reduced electron mass (μ≈mₑ), by choosing an appropriate near-resonance wavelength. Without getting into the details of atomic physics calculations, in this section we shall rely upon the well-established theoretical and experimental fact that such near-resonance condition can be satisfied, that is, the polarizability can be made larger than the static value by a factor, αₙᵣ, which can be as large as αₙᵣ˜10⁵ [23].

Another strategy to produce values of the polarizability that are vastly larger than the static value is to use Rydberg atoms. A qualitative argument in favor of this choice is that, as we have seen above, the static polarizability is α₀=(2a₀)³, where a₀ is Bohr's radius. If the atom is in a Rydberg state, that is, in an excited state with relatively large principal quantum number n>>1, the atomic radius can be replaced by aₙ=a₀n². On the strength of this argument alone, the atomic polarizability of a Rydberg state appears proportional to n⁶. In fact, if one accounts for all states with different orbital quantum number l, the static polarizability of a Rydberg atom results proportional to n⁷. For instance, the atomic radius of atoms in one-electron Rydberg states with n˜10², which are routinely created in the laboratory and are present in interstellar space, is ˜10⁴a₀—similar to the size of an Ebola virus! Under these circumstances, the static polarizability is a stunning ˜10¹⁴ times larger than its static value [19, 30, and Refs. therein].

From the practical standpoint, it is important to notice that Rydberg atoms gases have already been “frozen” and trapped in order to study, among others, the very dipole-dipole interactions we discussed at the very beginning of this disclosure [31]. The atoms themselves are prepared by causing them to absorb laser light of wavelength appropriate to induce a radiative transition to the desired excited state. Noticeably, the radiative lifetime of Rydberg atoms can be quite long, even compared to the relatively short crossing time within the propulsive system. The choice of atoms in states other than the ground state, such as Rydberg atoms, imposes an additional constraint upon the interatomic distance, since the radius of these atoms can be macroscopic. It is therefore important to require that the interatomic distance be much larger than the Rydberg atom radius, which in turn affects the size of the entire propulsive system.

It is appropriate at this time to again stress the difference between the atom-atom force, which is related to the dependence of the dispersion energy on the interatomic distance and is a central force, and the vertical lifting force acting upon all atoms as a consequence of the modification of their interaction potential in an accelerated reference frame. For instance, let us again consider the potential energy of a pair of atoms (Eq. (12)) and let us rewrite it to highlight the close similarity to the gravitational case:

$$\begin{matrix}Δ E = - {G}_{QED} \frac{{α}_{A} ( {k}_{L} ) {α}_{B} ( {k}_{L} )}{R} , & {k}_{L} R ⪡ 1 ,\end{matrix} \qquad ( 12 a )$$

where the equivalent quantum-electro-dynamical “gravitational constant” is, by definition:

$${G}_{QED} ≡ \frac{176 {π}^{3}}{15 c} \frac{I}{{λ}_{L}^{2}} , \qquad ( 15 )$$

and the dynamic polarizabilities play the role of the “gravitational mass.” The total potential energy can then be written as usual:

$${U}_{gas} = - \frac{1}{2} {G}_{QED} {\sum }_{i \neq j} \frac{{α}_{i} ( {k}_{L} ) {α}_{j} ( {k}_{L} )}{{R}_{ij}} , \qquad ( 16 )$$

where the summation is meant over all pairs and Rᵢⱼ is the magnitude of the interparticle distance vector, Rᵢⱼ.

Every atom in the gas is acted upon by a gravitational-like self-force and thus undergoes an acceleration g_{QED} towards the center of the cloud (assumed approximately spherical) similar to a typical gravitational acceleration. This is in complete analogy to the collapse of a “cold” gas sphere taking place whenever the gravitational pressure is vastly larger than any opposing gas pressure gradient. The order of magnitude of the time required for the entire cloud to collapse to its center is an important characteristic time in stellar evolution and in stellar dynamics, and it is referred to as the free-fall time [32-33]. In order to generalize this quantity to our case, let us consider the equation of motion of a particle (atom) in the above potential at a distance r from the center of the cloud with α_{A}(k_{L})=α_{B}(k_{L}) and N_{A}>>1. In this case it is well-known from elementary mechanics that Gauss' Theorem allows us to only consider the force exerted by the atoms inside a sphere of radius equal to r and we find:

$$\ddot{r} = - {G}_{QED} \frac{{α}_{A}^{2} ( {k}_{L} )}{{r}^{2}} \frac{1}{{m}_{A}} . \qquad ( 17 )$$

Since we are only estimating an order of magnitude, let us assume, as done typically, that the acceleration is approximately constant during the free-fall process. Thus:

$$\frac{1}{2} \ddot{r} {t}_{ff}^{2} ∼ D ,$$

which yields, for r˜D

$$\begin{matrix}{t}_{ff} ∼ \sqrt{\frac{2 D}{\ddot{r}}} \\ ∼ \sqrt{\frac{2 {N}_{A} {\overline{R}}^{3}}{{G}_{QED} {α}_{A}^{2} ( {k}_{L} ) {m}_{A}}} .\end{matrix} \qquad ( 18 )$$

Finally, by substituting Eq. (15) into this result, we obtain:

$${t}_{ff} ∼ \sqrt{\frac{2 {N}_{A} {\overline{R}}^{3}}{{α}_{A}^{2} ( {k}_{L} )} \frac{15 c}{176 {π}^{3}} \frac{{λ}_{L}^{2}}{I} {m}_{A}} . \qquad ( 19 )$$

The importance of this result lies with the fact that the physics of the system after such free-fall time must be expected to be substantially different than in its initial state. For instance, in the case of atoms in their Rydberg states, a drastic evolution of the system towards a higher density configuration can be expected to result in the transformation of the gas into a neutral plasma, with consequent complete loss of thrust.

The condition to be required so that the atoms do not have the time to evolve into an extremely different, and technologically useless, state is that the free-fall time above be much longer than the time the atoms spend in the trap before the lifting force causes them to be ejected, Δt_{A}. Evidently, if the gas evolves into, for instance, a plasma upon ejection, that is of no consequence to the momentum it will transfer to the vehicle. By using the result below at Eq. (40), we can write this requirement as:

$$\begin{matrix}{t}_{ff} ⪢ Δ {t}_{A} , & ( 20 ) \\ or & \\ \sqrt{\frac{2 {N}_{A} {\overline{R}}^{3}}{{α}_{A}^{2} ( {k}_{L} )} \frac{15 c}{176 {π}^{3}} \frac{{λ}_{L}^{2}}{I} {m}_{A}} ⪢ \sqrt{\frac{\overline{R} {N}_{A}^{1 / 3}}{[ \frac{4 {π}^{2}}{{c}^{3}} {N}_{A} ( \frac{I}{{λ}_{L}^{2}} ) \frac{{α}_{A}^{2} ( {k}_{L} )}{\overline{R} {N}_{A}^{1 / 3} {m}_{A}} - 1 ] g}} , & ( 21 )\end{matrix}$$

If the lift acceleration is much larger than g, the term in square brackets in the denominator of the right-hand-side will become much larger than unity so that term can be neglected and we easily find the limiting condition:

$${N}_{A} \frac{D g}{{c}^{2}} ⪢ \frac{22}{15} π . \qquad ( 22 )$$

This condition, which of course results also by requiring that a_{A}>>\ddot{r}, can be satisfied by realistic values of the geometry of the propulsive system, although it clearly points to the usefulness of employing larger traps, for which N_{A}>>1.

That the physical state of the gas can in fact be extreme after a few free-fall times if this is not accomplished, can be seen by writing the condition that the gas be in equilibrium under the action of this gravity-like interaction. As well-known, gravitationally bound systems do not display what can be properly referred to as equilibrium configurations in the thermodynamical sense. This is well illustrated by an appropriate similitude between the cold gas in the propulsive system of this invention and a globular star cluster—a spherical system in which thousands to hundreds of thousands of stars are bound by their mutual gravitational interaction—or, alternatively, a star [22].

In a globular cluster (or in a star), the distribution of velocities of the constituent particles “relaxes” to a quasi-Maxwellian velocity distribution after a time properly referred to as the “relaxation” time of the object. However, a Maxwellian velocity distribution contemplates a finite number of particles whose speeds at any given time are higher than the escape velocity from the system. Therefore there occurs a process of constant evaporation, which clearly forbids the existence of any equilibrium configuration [32-35].

However, it is possible to define a condition of quasi-equilibrium, in which a gravitationally bound system does not change drastically over many relaxation times. Under these conditions, the object obeys a general theorem referred to as the virial theorem, which links its total average kinetic and potential energies. This connection is very powerful, as it allows one to obtain estimates of the average speeds of its particles, whether they be stars or atoms [35-36]. For the purposes of our estimates here, this very general theorem can be written as
2<K_{gas}>+<U_{gas}>=0, (23)
where K_{gas} is the total kinetic energy and the triangular brackets indicate the time-average. By writing the total kinetic energy as

$$\begin{matrix}{K}_{gas} = \frac{3}{2} {N}_{A} {k}_{B} {T}_{gas} \\ = \frac{1}{2} {N}_{A} {m}_{A} 〈 {v}_{A}^{2} 〉 ,\end{matrix}$$

and by approximating <1/D>=1/<D>, the virial theorem yields:

$$\begin{matrix}{T}_{gas} = \frac{8 {π}^{2}}{3 {k}_{B} c} {N}_{A} \frac{I}{{λ}_{L}^{2}} \frac{{α}_{A}^{2} ( {k}_{L} )}{D} , & ( 24 ) \\ and & \\ {v}_{A} = \sqrt{\frac{8 {π}^{2}}{3 c} \frac{{N}_{A}}{{m}_{A}} \frac{I}{{λ}_{L}^{2}} \frac{{α}_{A}^{2} ( {k}_{L} )}{D}} , & ( 25 )\end{matrix}$$

The physical significance of these equations can be found by imposing the condition that the average kinetic energy be equal to the ionization potential of the atoms E_{I} in the gas so that the atoms may become ionized as they collide, in analogy to the Saha and Boltzmann equations of stellar astrophysics [33]:

$$\frac{3}{2} {k}_{B} {T}_{gas} ∼ \frac{{E}_{0}}{{n}^{2}} , \qquad ( 26 )$$

where the right-hand-side of the above equation contains the ionization potential of a hydrogen atom in its n-th state and E₀ is the ionization energy of the ground state. By using Eq. (24), this yields:

$$\frac{4 {π}^{2}}{c} {N}_{A} \frac{I}{{λ}_{L}^{2}} \frac{{α}_{A}^{2} ( {k}_{L} )}{D} ∼ \frac{{E}_{0}}{{n}^{2}} , \qquad ( 27 )$$

which can be expressed in even more fundamental terms in the case of Rydberg atoms as:

$$\begin{matrix}\frac{4 {π}^{2}}{c} {N}_{A} \frac{I}{{λ}_{L}^{2}} \frac{{( 2 {a}_{0} )}^{6} {n}^{14}}{D} ∼ \frac{{e}^{2}}{2 {a}_{0} {n}^{2}} , & ( 27 ) \\ or & \\ \frac{4 {π}^{2}}{{e}^{2} c} {N}_{A} \frac{I}{{λ}_{L}^{2}} \frac{{( 2 {a}_{0} )}^{7} {n}^{16}}{D} ∼ 1. & ( 28 )\end{matrix}$$

In the near-resonance case we can instead write:

$$\frac{4 {π}^{2}}{{E}_{0} c} {N}_{A} \frac{I}{{λ}_{L}^{2}} \frac{{( 2 {a}_{0} )}^{6} {α}_{n r}^{2}}{D} ∼ 1 , \qquad ( 29 )$$

Replacing the numerical values we shall produce below in a few realistic examples, it is immediate to conclude that the almost immediate ionization of the entire atomic population is highly likely in all technologically meaningful cases, and that, as already pointed out in this section, it is imperative to choose parameters that ensure the expulsion of the gas from the trap well before this process is completed.
4.1.2 Validity of the Present Approach

In this subsection we concern ourselves with the possible limitations of our treatment. Let us first of all notice that we have so far dealt with atoms in the trap as “classical” objects, that is, as material particles whose positions and velocities can be likened to those of stars in a cluster, for instance. This is approximately correct only if the de Broglie wavelength λ_{A} of the atoms is much smaller than the interatomic distance, that is, if:

$${λ}_{A} ≡ \frac{h}{{p}_{A}} \approx \frac{h}{{m}_{A} {υ}_{A}} \overline{R} , \qquad ( 30 )$$

where p_{A} is the momentum of the atoms and the middle step is warranted for non-relativistic speeds. This condition may be violated for extremely low temperatures and for high densities, such as those of artificial “white dwarfs,” and in these cases the gas must be treated as a quantum gas of the appropriate statistics as is the case, for instance, in white dwarf stars [22, 33]. Although such extreme conditions are only marginally important to the present work, a well-established theoretical framework exists in the literature to describe them.

Secondly, the basic result at Eq. (12) is rigorously valid only within fourth-order perturbation theory [21]. An order of magnitude of the regime within which our results are certainly warranted can thus be found by requiring that the energy shift per atom due to the total intermolecular force of the gas cloud be much smaller than the energy of the n-th unperturbed state occupied by the atoms, that is:
|Eₙ|>>N_{A}|ΔE|, (31)
or, for hydrogen atoms:

$$\begin{matrix}\frac{{ⅇ}^{2}}{2 {a}_{n}} \frac{176 {π}^{3}}{15 c} {N}_{A} \frac{I}{{λ}_{L}^{2}} \frac{{α}_{A}^{2} ( {λ}_{L} )}{D} = \frac{176 {π}^{3}}{15 c} {N}_{A} \frac{W}{18 {N}_{A}^{2 / 3} {\overline{R}}^{2}} \frac{1}{{λ}_{L}^{2}} \frac{{α}_{A}^{2} ( {λ}_{L} )}{{N}_{A}^{1 / 3} \overline{R}} \\ = \frac{176 {π}^{3}}{270 c} \frac{W}{{\overline{R}}^{3}} \frac{1}{{λ}_{L}^{2}} {α}_{A}^{2} ( {λ}_{L} ) ,\end{matrix} \qquad ( 32 )$$

where the relationship between total power and intensity at Eq. (48) was used. Let us consider only the s-state polarizability as αₙ(λ_{L})=αₙᵣ(2aₙ)³ and let us write the average intermolecular distance in terms of the atomic radius as \overline{R}=\overline{r}aₙ. Finally, by recalling that aₙ=a₀n², we find:

$$\begin{matrix}\frac{{ⅇ}^{2}}{2 {a}_{0} {n}^{2}} \frac{1.2 \times {10}^{3}}{c} \frac{W}{{\overline{r}}^{3} {a}_{0}^{3} {n}^{6}} \frac{1}{{λ}_{L}^{2}} {α}_{nr}^{2} ( {λ}_{L} ) {a}_{0}^{6} {n}^{12} , \\ or & ( 33 ) \\ \frac{W}{{\overline{r}}^{3}} \frac{{α}_{nr}^{2} ( {λ}_{L} )}{{λ}_{L}^{2}} {n}^{8} \frac{{ⅇ}^{2}}{2 {a}_{0}^{4}} \frac{c}{1.2 \times {10}^{3}} \sim 4 \times {10}^{21} . & ( 34 )\end{matrix}$$

The dynamical consequences of this constraint can be seen by recalling our basic Eq. (14) written by making use of the first two terms of Eq. (32):

$$\frac{{a}_{lift , z}}{g} = \frac{4 π}{c} {N}_{A} ( \frac{I}{{λ}_{L}^{2}} ) \frac{{α}_{A}^{2} ( {λ}_{L} )}{D} \frac{1}{{m}_{A} {c}^{2}} \frac{60}{176 {π}^{2}} \frac{{ⅇ}^{2}}{2 {a}_{n}} \frac{1}{{m}_{A} {c}^{2}} . \qquad ( 35 )$$

In order to extract a physical meaning from this requirement, let us consider the problem of bringing the gas cloud to a hover from a different standpoint. The condition of balance between weight and lift of one atom is given by Eq. (14) above:

$$\frac{{a}_{lift , z}}{g} \sim \frac{{F}_{lift , z}^{gas}}{{N}_{A} {m}_{A} g} = {N}_{A} ( \frac{{Ik}_{L}^{2}}{c} ) \frac{{[ {α}^{A} ( {k}_{L} ) ]}^{2}}{D} \frac{1}{{m}_{A} {c}^{2}} . \qquad ( 14 )$$

By using the expression for the potential of one pair at Eq. (12), we can express this condition by introducing the total intermolecular energy of one atom due to all the others, N_{A}ΔE:

$$\frac{{a}_{lift , z}}{g} \sim \frac{Δ E}{{m}_{A} {c}^{2}} . \qquad ( 36 )$$

With the usual strong caveats of using our non-quantum “intuition” to interpret results in the realm of quantum-electro-dynamics (QED) in curved space-time, a possible qualitative view of this hovering condition is that this requirement corresponds to having the total (negative) intermolecular potential of the gas cloud cancel its total gravitational mass, thus resulting in atoms which are, for all practical purposes, “weightless.” By going further, it is possible to consider intermolecular potentials which are negative and larger in magnitude than the gravitational mass of the atoms, thus causing the total energy of the cloud to become effectively negative. According to Newton's Law of Gravitation, this would require the atoms to be “repelled by gravity,” instead of being attracted. Although this is an interesting and useful image—which has in fact been pursued by Boyer in the past [16]—one has to be extremely careful to adopt it as an “explanation.”

In the scheme of the present invention, the upward lifting force does not result from such view, but from the well-understood distortion of the Coulomb potential due to the presence of the gravitational field. Although Boyer's work proved these two points of view to be equivalent [16], his study dealt with completely classical dipoles within the realm of special relativity and very weak gravity, and not with fully quantized atoms with the framework of QED in curved space-time. Since one possible interpretation of dispersion forces between molecules involves a modification of the zero-point-energy of the quantum vacuum [37], such simple “semi-classical” explanations should be looked at only as useful mental pictures, since the “system” under consideration is actually an open system.

In this context, two possible objections must be addressed. The first is whether it is at all correct to use perturbation theory in this case. After all, in order to bring a cloud of hydrogen atoms to a hover, the intermolecular potential must contribute an energy approximately equal to the rest-mass of a hydrogen atoms, or ≈1 GeV, whereas the ionization potential of a hydrogen atom is 13.59 eV if the atom is in its ground state and much less if it is in a Rydberg state. The intermolecular potential will be vastly larger if we want to achieve an upward acceleration. The answer rests with the key fact that, in our case, the processes we are studying take place on relatively “short” time-scales. At some time after the cloud of atoms has been cooled and trapped, a very intense beam of radiation is turned on within a total time that will be assumed to be much shorter than that of any possible atomic transition. For instance, the radiative lifetimes of very high n Rydberg atoms can be even fractions of a second, whereas lasers can be turned on in fractions of a nanosecond (10⁻⁹ s) and that radiation will require a similar time to cross the entire trap at the speed of light.

A well-known feature of the perturbation theory of “sudden” interactions is that the perturbation does not have to be small for theory to be used, unlike most other applications of perturbation theory, as stated, for instance in [38] (see also [39-41]): “The transition probabilities in instantaneous perturbations can also be found in cases where the perturbation is not small . . . If the change in the Hamiltonian occurs instantaneously (i.e. in a time short compared with the periods 1ω_{if} of transitions from the given state i to other states), then the wavefunction of the system is “unable” to vary and remains the same as before the perturbation. It will no longer, however, be an eigenfuction of the new Hamiltonian Ĥ of the system . . . ”

By making further use of this same mental picture, we can say that in the description of the fundamental physical process at the basis of the present invention we assume that the phase of upward acceleration of the atoms takes place in the very early stages immediately following the application of the laser radiation field and before the eventual modification of the wavefunctions intervenes. In other words, there exists a relatively brief time span immediately following the laser turn-on time, during which the atomic dipoles still behave as such, although, eventually, the gas evolves towards a very different state, such as a plasma for instance. Part of the refining work of the present invention will be to consider in detail the dynamics of the evolution of the atoms in the intense radiation field. However, the references quoted show that there is a solid logical foundation in the use of perturbation theory in the present case due to the instantaneous application of the radiation field.

The second objection to consider is whether it is against any fundamental law of physics to even consider the existence of a volume of space where the total energy is negative, as appears to be necessary in order to obtain a gravitational “repulsion” of the atoms. We have already provided a first hint above that one answer to this objection is that it is not at all necessary to look at this process as being due to a “negative” energy. In fact, one alternative and much more satisfactory way to explain the upward motion of the atoms is to appeal to the distortion of the dipole-dipole field due to the acceleration in the presence of a gravitational field. The distortion of the field lines due to the presence of gravitational appears to be a much firmer concept than that of a “negative” energy.

However, even if one wants to engage in the widespread debate concerning the existence of negative energy, it is interesting to point out that dispersion forces in general and Casimir forces in particular are in fact commonly used as examples to the affirmative. In other words, whereas there exist strict quantum limits, similar to the uncertainty principle, as to the length of time a very negative energy density can be imposed upon a volume of space, dispersion forces clearly afford an example where the energy density can remain negative indefinitely (although the same limitations apply if one attempts to decrease the energy even further). The important point to the present invention is that there is no fundamental physical reason that dispersion forces cannot be made negative for the brief time needed to accelerate the atoms upward as required to provide thrust. On the other hand, much more exotic and fantastic applications of negative energy to “warp-drives,” “time-machines,” and “faster-than-light” travel, which now appear forbidden by fundamental laws of quantum mechanics in curved space-time [42-45] are not involved in the physical processes of this invention.

4.1.3 Thrust

By using Eq. (13) above, we can write the total lifting force on the trapped atoms in the case that α_{A}(k_{L})=α_{B}(k_{L}), by assuming that the average of the interatomic distance between any given atom and all others is ˜D, as:

$${F}_{gas} = {N}_{A}^{2} {F}_{z}^{AB} = \frac{4 {π}^{2}}{{c}^{3}} {N}_{A}^{2} ( \frac{I}{{λ}_{L}^{2}} ) \frac{{α}_{A}^{2} ( {k}_{L} )}{D} g . \qquad ( 37 )$$

Let us now consider the total momentum acquired by the gas as it flows out of the atomic trap. Without getting into the details of the dynamics of such process, which certainly deserve further consideration, let us consider the acceleration of the atoms under the action of the lifting force, F_{gas}. In an inertial reference frame, the total acceleration undergone by the atoms would be F_{gas}/N_{A}m_{A}, but, in this non-inertial frame, the acceleration will be (F_{gas}−N_{A}m_{A}g)/N_{A}m_{A}=(F_{gas}/N_{A}m_{A})−g. For instance, if the lifting force is exactly equal to N_{A}m_{A}g, the atoms will not accelerate with respect to the vehicle, but only hover, as we have seen in the above theoretical treatment. Therefore:

$${a}_{A} = \frac{{F}_{gas}}{{N}_{A} {m}_{A}} - g = [ \frac{4 {π}^{2}}{{c}^{3}} {N}_{A} ( \frac{I}{{λ}_{L}^{2}} ) \frac{{α}_{A}^{2} ( {k}_{L} )}{( \overline{R} {N}_{A}^{1 / 3} ) {m}_{A}} - 1 ] g . \qquad ( 38 )$$

At this rate, the average final velocity of the atoms will be v_{A,fin}=\sqrt{2a_{A}(D/2)}:

$$\begin{matrix}{υ}_{A , fin} = \sqrt{( \frac{{F}_{gas}}{{N}_{A} {m}_{A}} - g ) \overline{R} {N}_{A}^{1 / 3}} \\ = \sqrt{[ \frac{4 {π}^{2}}{{c}^{3}} {N}_{A} ( \frac{I}{{λ}_{L}^{2}} ) \frac{{α}_{A}^{2} ( {k}_{L} )}{( \overline{R} {N}_{A}^{1 / 3} ) {m}_{A}} - 1 ] g \overline{R} {N}_{A}^{1 / 3}} ,\end{matrix} \qquad ( 39 )$$

where, of course, the application considered in this invention considers only circumstances in which the radical is real.

It is also of interest to find an order of magnitude for the time required to leave the atomic trap defined as

$$\frac{1}{2} D = \frac{1}{2} {{a}_{A} ( Δ {t}_{A} )}^{2} ,$$

which sets a lower minimum to the “reload” time of the thrust cycle:

$$\begin{matrix}Δ {t}_{A} = \sqrt{\frac{D}{{a}_{A}}} \\ = \sqrt{\overline{R} {N}_{A}^{1 / 3} \frac{1}{\frac{{F}_{gas}}{{N}_{A} {m}_{A}} - g}} \\ = \sqrt{\frac{\overline{R} {N}_{A}^{1 / 3}}{[ \frac{4 {π}^{2}}{{c}^{3}} {N}_{A} ( \frac{I}{{λ}_{L}^{2}} ) \frac{{α}_{A}^{2} ( {k}_{L} )}{\overline{R} {N}_{A}^{1 / 3} {m}_{A}} - 1 ] g}} ,\end{matrix} \qquad ( 40 )$$

From Eq. (39) we can immediately write the total momentum of the gas, ΔP_{gas}, for each cycle at it approaches the shock absorber:

$$\begin{matrix}Δ {P}_{gas} = {m}_{gas} {υ}_{A , fin} = {N}_{A} {m}_{A} \sqrt{( \frac{{F}_{gas}}{{N}_{A} {m}_{A}} - g ) \overline{R} {N}_{A}^{1 / 3}} , \\ or & ( 41 ) \\ Δ {P}_{gas} = {N}_{A} {m}_{A} \sqrt{[ \frac{4 {π}^{2}}{{c}^{3}} {N}_{A} ( \frac{I}{{λ}_{L}^{2}} ) \frac{{α}_{A}^{2} ( {k}_{L} )}{\overline{R} {N}_{A}^{1 / 3} {m}_{A}} - 1 ] g \overline{R} {N}_{A}^{1 / 3}} , & ( 42 )\end{matrix}$$

Finally, let us estimate the total momentum transferred to the vehicle in the assumption that the impact of the gas against it is dissipative, that is, by assuming the complete conservation of momentum. In this case, the final speed change of the (gas+craft) system at the end of the n-th cycle will be given by m_{gas}v_{A,fin}=(m_{gas}+M_{craft})Δvₙ. That is, by solving for Δvₙ,

$${Δυ}_{n} = \frac{{N}_{A} {m}_{A}}{{N}_{A} {m}_{A} + {M}_{craft}} \sqrt{[ \frac{4 {π}^{2}}{{c}^{3}} {N}_{A} ( \frac{I}{{λ}_{L}^{2}} ) \frac{{α}_{A}^{2} ( {k}_{L} )}{( \overline{R} {N}_{A}^{1 / 3} ) {m}_{A}} - 1 ] g \overline{R} {N}_{A}^{1 / 3}} . \qquad ( 43 )$$

Although the acceleration of the vehicle varies over time during the cycle, it is useful to introduce an average acceleration over the cycle itself, we the understanding that the acceleration experienced by the atoms during their phase of acceleration may be different, and usually higher, than this value because of the cycle synchronization we discussed earlier. We write:

$${a}_{craft} = \frac{{Δυ}_{n}}{Δ {t}_{A} + Δ {t}_{Reload}} , \qquad ( 44 )$$

where Δt_{Reload} is the time required to prepare the new atomic cloud in the trap for the following cycle. This definition allows us to also define a nominal thrust for the engine as:
F_{engine}=(N_{A}m_{A}+M_{craft})a_{craft}. (45)

In the limit in which the reload time vanishes (Δt_{Reload}→0), of course we find, as expected:

$$\begin{matrix}{a}_{craft} -> \frac{{Δυ}_{n}}{Δ {t}_{A}} = \frac{{N}_{A} {m}_{A}}{{N}_{A} {m}_{A} + {M}_{craft}} {a}_{A} , \\ and & ( 46 ) \\ {F}_{engine} -> {F}_{gas} . & ( 47 )\end{matrix}$$

In this ideal limit, the hovering condition becomes that F_{gas}=(N_{A}m_{A}+M_{craft})g, that is, the total force on the atomic cloud must be equal to the weight of the entire vehicle. This is also the thrust that could be obtained if the atomic cloud could be trapped permanently within the chamber even as it acts on the vehicle via the action-reaction law.
4.1.4 Energy Considerations and Thruster Efficiency

The total radiation power utilized will be estimated as W=18ID², which corresponds to six laser triads (this is an upper estimate of the power needed as it is possible to induce gravitation-like behavior in a particular direction by using less power than this maximum). This yields:
W=18IN_{A}^{2/3}\overline{R}². (48)
By solving this expression for the radiation flux I, we find:

$$I = \frac{W}{18 {N}_{A}^{2 / 3} {\overline{R}}^{2}} . \qquad ( 49 )$$

This result allows us to obtain a realistic estimate of the relationship between the dynamics of the process and the total amount of energy needed. For instance, by substituting it into Eq. (38), we obtain the following useful expression:

$${a}_{A} = [ \frac{2 {π}^{2}}{9 {c}^{3}} ( \frac{W {α}_{A}^{2} ( {k}_{L} )}{{R}^{3} {λ}_{L}^{2} {m}_{A}} ) - 1 ] g , \qquad ( 50 )$$

which exposes the interesting fact that, in the present approximation, the atomic acceleration as a function of the total laser power irradiated is independent of the number of atoms in the trap. By means of this equation, it is possible to write the total power needed to be focused onto the trap to achieve a hover, that is, a vanishing acceleration of the atoms with respect to the vehicle. This corresponds to:

$${W}_{hover} = \frac{9 {c}^{3}}{2 {π}^{2}} \frac{{\overline{R}}^{3} {λ}_{L}^{2} {m}_{A}}{{α}_{A}^{2} ( {k}_{L} )} , \qquad ( 51 )$$

independently of g. For practical reasons, let us rewrite this result in units of Megawatts (MW) in terms of the wavelength in micrometers, λ(μm), of the average interatomic distance in units of Bohr radii, \overline{R}/a₀, and by involving the dimensionless polarizability factor as α_{A}(k_{L})=αₙᵣ(k_{L})α₀:

$${W}_{hover} = 2.18 \times {10}^{9} \frac{{( \overline{R} / {a}_{0} )}^{3} {λ}_{L}^{2} ( μm )}{{α}_{nr}^{2} ( {k}_{L} )} MW , \qquad ( 52 )$$

Of course this result should be interpreted as allowing the atoms to be brought to a hover for a time no longer than the free-fall time given at Eq. (19) above unless an independent trapping approach is employed to hold the atoms at constant intermolecular distances, such as in an optical crystal.

Similarly for Eqs. (17), (18), (20), and (21):

$$\begin{matrix}{υ}_{A , fin} = \sqrt{[ \frac{2 {π}^{2}}{9 {c}^{3}} ( \frac{W {α}_{A}^{2} ( {k}_{L} )}{{\overline{R}}^{3} {λ}_{L}^{2} {m}_{A}} ) - 1 ] g \overline{R} {N}_{A}^{1 / 3}} . & ( 39 a ) \\ Δ {t}_{A} = \sqrt{\frac{\overline{R} {N}_{A}^{1 / 3}}{\frac{2 {π}^{2}}{9 {c}^{3}} ( \frac{W {α}_{A}^{2} ( {k}_{L} )}{{\overline{R}}^{3} {λ}_{L}^{2} {m}_{A}} ) - 1} \frac{1}{g}} , & ( 40 a ) \\ Δ {P}_{gas} = {N}_{A} {m}_{A} \sqrt{[ \frac{2 {π}^{2}}{9 {c}^{3}} ( \frac{W {α}_{A}^{2} ( {k}_{L} )}{{\overline{R}}^{3} {λ}_{L}^{2} {m}_{A}} ) - 1 ] g \overline{R} {N}_{A}^{1 / 3}} , & ( 42 a ) \\ {Δυ}_{n} = \frac{{N}_{A} {m}_{A}}{{N}_{A} {m}_{A} + {M}_{craft}} \sqrt{[ \frac{2 {π}^{2}}{9 {c}^{3}} ( \frac{W {α}_{A}^{2} ( {k}_{L} )}{{\overline{R}}^{3} {λ}_{L}^{2} {m}_{A}} ) - 1 ] g \overline{R} {N}_{A}^{1 / 3}} , & ( 43 a )\end{matrix}$$

with the same restrictions on the duration of the impulse.

The ratio of thrust to radiation pressure: This dimensionless quantity compares the thrust obtained from the present thrust mechanism to the radiation pressure one would obtain by simply radiating away the power used instead to alter the intermolecular potential. Clearly one expects this quantity to be much larger than unity in order for the approach of this invention to be of practical use. Should that not be so, the case could be made that focusing the radiation onto an appropriately large sail would be a more efficient use of that energy. We have, in the ideal case in which the reload time vanishes,

$$\frac{{F}_{gas}}{{P}_{rad}} = \frac{1}{W / c} {N}_{A} {m}_{A} [ \frac{2 {π}^{2}}{9 {c}^{3}} ( \frac{W {α}_{A}^{2} ( {k}_{L} )}{{\overline{R}}^{3} {λ}_{L}^{2} {m}_{A}} ) - 1 ] g . \qquad ( 53 )$$

In the limit in which a_{A}>>g, we have, simply:

$$\frac{{F}_{gas}}{{P}_{rad}} -> {N}_{A} \frac{2 {π}^{2}}{9 {c}^{2}} ( \frac{{α}_{A}^{2} ( {k}_{L} )}{{\overline{R}}^{3} {λ}_{L}^{2}} ) g . \qquad ( 54 )$$

Typical estimates of this quantity in interesting cases indeed indicate values much larger than unity for this quantity.

As in any other system that does not make use of the traditional expulsion of high speed gases to generate momentum (e.g. light sails), one must introduce new figures of merit. For instance, the typical concept of the specific impulse (the ratio of engine thrust to the weight of the material ejected in the unit time) [29], requires special attention in this case. Let us consider the case of a thrust system in which all radiation emitted by the high power lasers is permanently lost and radiated away from the spacecraft. Because of the mass-energy equivalency, this will correspond to a net mass-loss of the vehicle at a rate M_{craft}=−W/c². In the literature, the “photon rocket,” which annihilates matter and antimatter to eject the corresponding radiation in a particular direction, is defined by theoreticians as the “perfect” rocket engine, because it yields the highest terminal speed at burnout for the same final to initial mass ratio [46]. However, whereas in that case the thrust is directly due to the reaction to the emitted photons, in our case the presence of the radiation in the chamber where the atoms are trapped is only a catalyst to create the thrust upon the vehicle. Thus, since the origin of the thrust in our case is not the lost radiation one could just as convincingly argue that the specific impulse becomes undefined in this case.

From the quantitative standpoint, therein lies the great interest of the approach of the present invention. That is, for the same amount of energy expended, the thrust derived is much higher than that obtainable in the photon rocket [46]. At the same time, this high thrust does not come at the price of an impulsive propulsive system as in chemical engines, but one that can actually provide high accelerations over almost indefinite periods of time [47].

Thruster efficiency: This is the ratio of the kinetic energy of the atomic cloud as it emerges from the trap to the total energy used during the acceleration of the gas. By using the above expression for the final velocity of the atoms, this quantity can be written as:

$$\begin{matrix}\frac{\frac{1}{2} {N}_{A} {m}_{A} {v}_{A , fin}^{2}}{Δ {t}_{A}} \frac{1}{W} = \frac{{N}_{A} {m}_{A}}{\sqrt{2}} {a}_{A}^{3 / 2} {D}^{1 / 2} \frac{1}{W} \\ = {\frac{{N}_{A} {m}_{A}}{\sqrt{2}} [ \frac{2 {π}^{2}}{9 {c}^{3}} ( \frac{W {α}_{A}^{2} ( {k}_{L} )}{{\overline{R}}^{3} {λ}_{L}^{2} {m}_{A}} ) - 1 ]}^{3 / 2} \\ \frac{{g}^{3 / 2} {\overline{R}}^{1 / 2} {N}_{A}^{1 / 6}}{W} .\end{matrix} \qquad ( 55 )$$

In the same limit a_{A}>>g we find:

$$\frac{\frac{1}{2} {N}_{A} {m}_{A} {v}_{A , fin}^{2}}{Δ {t}_{A}} \frac{1}{W} \to {( \frac{W}{2 {m}_{A}} )}^{1 / 2} {\frac{1}{{\overline{R}}^{4}} [ \frac{2 {π}^{2}}{9 {c}^{3}} ( \frac{{α}_{A}^{2} ( {k}_{L} )}{{λ}_{L}^{2}} ) ]}^{3 / 2} {g}^{3 / 2} {N}_{A}^{7 / 6} . \qquad ( 56 )$$

Special care must be exercised in interpreting the results obtained by extrapolating this equation to values of the efficiency that exceed unity, since this may be an indication that other phenomena are becoming important. Furthermore, we have here neglected other forms of energy that are also required, such as, for instance, the radiation required to excite the atoms if Rydberg states are used and the energy used for the initial trapping. As shall become clear in the examples below, the present invention represents a useful and revolutionary technological innovation even in regimes where the thruster efficiency is below unity.
4.2 Start-Up, Maneuvers, Cruise, and Turn-Off

The fundamental, basic physics principle of this invention is the distortion of the field of a dipole in an accelerated reference frame and the resulting “lifting” dipole-dipole force. In order for this principle to operate, an acceleration must be induced upon the dipole system before the thrust on it can appear. In other words, it is not possible to turn on the thrusting system of this invention from a cruise phase (approximately at constant speed). Because of the Principle of Equivalence, such initial acceleration can be provided by means of any combination of two different, but equivalent mechanisms. In the former, the acceleration is due to gravitation, which provided the initial motivation for the present invention.

Because of the Principle of Equivalence, the effect of a gravitational field is indistinguishable from that a uniformly accelerated reference frame (if we neglect the Linet term mentioned in our comment of Eq. (3) and in Ref. [9] and quantitatively unimportant to this invention). Therefore, the trigger acceleration can be provided by the gravitational field as a supported (not freely falling system) rests, for instance on the ground. Because of the Principle of Equivalence, if the spacecraft is freely falling its acceleration exactly cancels that of the gravitational field and it becomes indistinguishable from a laboratory at a large distance from any other mass, to the extent that its size is relatively small.

Because of the mechanism of this invention, if the spacecraft is resting on the ground, upon laser turn-on, the intermolecular forces will be distorted in such a way as to cause an upward acceleration of the atoms, which can be made, for instance, as large as needed for the spacecraft to hover. On the other hand, if the spacecraft is in outer space at a large distance from any other celestial objects, such as in interplanetary flight, the initial acceleration must be provided by independent means. This can be achieved in a variety of ways. For instance: (1) an initial forward acceleration can be produced by a traditional thrusting system until the first few cycles of the present engine are produced—in this case the traditional thruster becomes an “ignition system” for the present invention; (2) the entire craft can be put into rotation around an appropriate axis, thus reproducing Einstein's rotating disk [46]; (3) on re-entry, a spacecraft undergoes an aerodynamic deceleration that can be used as the trigger.

The same above sample triggers can be also used for maneuvering, that is, to create an initial acceleration in a direction different than that of the present motion. This can be very useful to transform the present invention in a vehicle for motion near the surface of the earth. A slight acceleration parallel to the ground could be maintained with relatively little radiative energy while a larger amount of radiation would keep the vehicle hovering safely. A slow decrease in the power of the lasers, or any other change in the parameters determining the thrust, such as intermolecular distance or total atom number, would result in a decreased acceleration of the atoms and, thus, of the vehicle. In order to bring the vehicle to a cruise (constant speed) the only necessary action is to turn off the high power lasers, or, alternatively, to empty the atomic trap system of atoms. The acceleration upon the vehicle would then immediately stop along with the dipole-dipole field distortion, thus bringing the craft to constant velocity. Finally, a trigger acceleration can be exercised in a direction opposite to the instantaneous velocity to start an opposite thrust that brings the vehicle to a deceleration and to a new hover.

Although the notion of flying by exploiting an initial acceleration may appear counterintuitive, it must be said that a similar transition also challenges some pilots at the beginning of their training. In fact, flying through air requires speed to create lift from the airfoils and a slower and slower aircraft is unable to keep altitude. This concept requires constant training in beginning pilots today to fight the instinct to “pitch-up” to regain lost altitude on landing, as that can result in a stall. Similarly, the lifting mechanism of this invention requires the user to become sensitive to acceleration—as opposed to speed—and to the notion that an accelerating vehicle can maintain thrust, whereas one at constant speed will loose thrust.

4.3 Numerical Examples

The following numerical examples were generated by making use of a Mathematica notebook [13] which encoded the equations discussed in this document. The design of any of the missions below could (and does) take many years of study, but the goal of this section is to provide the information necessary to appreciate the fact that the physics of this invention leads to realistic engineering demands. In other words, whereas relativistic travel is usually assumed to require harnessing absolutely fantastic amounts of energy, the method below yields numbers that can be realistically contemplated to be put into feasible design with presently existing technologies.

Any space mission must start with some requirements, which are to some extent arbitrary or descend from other constraints. In the examples below, we assumed that all travel takes place at a given spacecraft acceleration a/g<1. This is to contrast the approach to space travel of this invention with typical designs, which either impose high (several g) accelerations for a short periods of time (chemical rockets) or provide very low thrust over very long periods of time, such in the case of ion propulsion, in which the author of this invention has been directly involved [47]. Let us recall that the present method requires that the intermolecular potential be distorted by the acceleration of the vehicle (or by gravitation if the vehicle is held at rest, as required by the Principle of Equivalence). Therefore, the acceleration of the vehicle due to the impact of a gas cloud into the plate determines the efficiency of the atomic acceleration in the following cycle.

According to the present method, space travel is most efficient when it is significantly accelerated. This is not a drawback, since, for instance, it is now understood that the dangers to human health of very long periods of weightlessness are significant. The data presented herein were thus produced by assuming a spacecraft acceleration a=g and then by demanding self-consistency, that is, by requiring that the spacecraft acceleration produced by any given gas cloud also be equal to g. Even with this requirement, the choices shows below represent only one of many possibilities chosen for their being realistic from the engineering standpoint or for their being representative of a contrast between the present invention and present-day technology. For simplicity, the reload time was everywhere assumed to be negligible.

4.2.1 A Robotic Low-Thrust Delivery System to the planet Mars

Propulsive System Specifications

W=35.0 MW=3.5×10¹⁴ erg/s
αₙᵣ=1×10⁶ (quasi-resonant response)
n=1 (ground state)
\overline{R}=5a₀
λ_{L}=1000 Å (quasi-Lyman-α transition)
M_{craft}=10⁷ g=10 metric tons
N_{A}=4.66×10²⁶
m_{gas}=7.86×10³ g=0.786 kg
Chamber Size D=20.3 cm
Wₕₒᵥₑᵣ(a_{craft}=1 g)=2.7 kW
a_{A}=1.28×10⁵ cm/s²
v_{A,fin}=2.29×10³ cm/s
Δt_{A}=1.79×10⁻² s
t_{ff}=60.6×10 s
Efficiency=3.3×10⁻⁴
Δv_{craft}/cycle=2.62 cm/s
a_{craft}=10 cm/s² (self-consistent)
Thrust=10.0 kN
(Thrust/Total Radiation Pressure)=8.57×10⁴
Earth-Mars distance at opposition (Aug. 27, 2003) 55.758×10¹¹ cm [48]
Total Travel time=1.52×10⁶ s=17 d 13 h 17 min 46.7 s
Maximum Speed (reached after=6×10⁵ s)=6.0×10⁶ cm/s=60 km/s
Maximum Kinetic Energy (reached after 6×10⁵ s)=1.8×10²⁰ erg
Total Energy Radiated (up to maximum speed)=2.1×10²⁰ erg
Time to Mach 1 (Speed of Sound v_{sound}≅331 m/s)=3.31×10³ s
Time to Clear Low-Earth-Orbit (400 km)=2.8×10³ s=47.1 min
Time to Clear the Earth-Moon System (4×10⁵ km)=8.94×10⁴ s=1 d 50.7 min
   Comments

In order to obtain the above estimates for the transfer to Mars, we greatly simplified the problem by neglecting the gravitational force of all objects involved, including the Sun, the Earth, and Mars. Of course, the gravitational force of the Earth is actually an integral part of the engine start-up mechanism of the present invention and in that sense its effect is accounted for here. However, since the gravitational field of all near-by objects is cleared in a matter of minutes, its influence on the dynamics of flight was neglected in these order-of-magnitude calculations.

It is useful to make come comparisons between the specifications of the system above and present-day delivery systems, since that helps elucidate the great technological relevance of the present invention. A typical choice for such recent space missions to Mars as the ones of Spirit and Opportunity is the Boeing Delta II 7925 or 7925H (the letter H indicates the more powerful high performance version) [49]. In its common configuration, the RS-27A engine of the Delta II first stage, along with the additional nine strap-on solid rocket motors, generates approximately 8.9×10⁵ Newtons of thrust, which are necessary to lift the total “wet” (fueled up) vehicle mass of 285, 228 kg off the launch pad. This thrust is almost one order of magnitude larger than that of the engine described in this document until the Main Engine Cut Off (MECO), approximately 265 s after lift-off. The thrust of the following stages is smaller, with the thrust of the third stage at approximately 6.6×10⁴ N.

Since the initial phase of ascent takes place under the thrust of a chemical rocket, not surprisingly we see that both in the case of Spirit and Opportunity the Delta II vehicle passes through Mach 1 in a much shorter time than the one propelled by the engine of this invention (32.4 s and 29.6 s, respectively) [50]. However, very importantly, by a very good approximation, the entire launch mass of 10 metric tons (10⁴ kg) is propelled towards Mars in the present case whereas, in the traditional approach, only 1.070×10³ kg out of the initial 285, 228 kg represent the useful remaining payload. Of this surviving mass, only 533 kg actually lands on Mars in the traditional case, since approximately 250 kg are allocated to the cruise stage alone.

Finally, the entire vehicle propelled by the engine of this invention arrives at Mars in a matter of less than twenty days, whereas both Spirit and Opportunity, extremely reduced in mass, arrive approximately six months later. It is very significant that the gravitational field of Mars, added to the deceleration of the spacecraft, makes the process of landing much slower and completely safe, in contrast with what NASA/JPL itself defines as the “six minutes of terror,” during which the vehicle must be slowed down from 12,000 miles/hr to 0 miles/hr corresponding to average accelerations a_{craft}˜1.5 g, although during the last drop the acceleration can reach ˜40 g [51]! In contrast, since the present vehicle is approaching Mars decelerating at a_{craft}=10 cm/s², the same process can be executed within over a week-long time and distributed over a path at uniform acceleration that concludes with the entire vehicle safely hovering at a desired height above the ground of the planet.

An obvious question when carrying out a comparison between traditional propulsion technology and the mechanism described in this document concerns the feasibility of generating ˜10⁻³-10⁻² s laser pulses requiring over 30 MWe (that is, MW of electric power) on board of a space vehicle. Is this possible? Has this possibility ever been carefully considered in the past? The answer to such legitimate question is that the study of high power, high efficiency, low-mass nuclear reactors for use in space applications is actually extremely advanced, although political and public opinion considerations tend to hide the enormous amount of available information away from the non-technical readership. A small selection of such literature, which cannot be cited here even partially because of its sheer size, can be found at [52] and References therein. General historic motivations behind this technical effort are to be found in the large energy needs of any hypothetical “Star Wars” defense system, in research into the possibility of interstellar travel, and, finally, in the recently renewed commitment to the human colonization of space made by the President of the United States and NASA. What is important to the evaluation of the engineering feasibility of the present invention is that, typically, reactor power densities in the order of ˜1-5 kW/kg are surely possible, with very wide variations in either direction of that estimate depending on the specifics of design and shielding requirements. However, the figure above is sufficient to make the case that, by means of presently existing technology, it is absolutely appropriate to consider a 10 ton-vehicle carrying a reactor able to produce pulses in the 30 MWe range in space.

The implications for human flight to Mars by means of the present invention are very significant as well. At present, the delivery of several tens of tons of payload to Mars is contemplated to take approximately 180 days, with a typical mission duration for the crew of 2-3 years. The overwhelming majority of the mission duration would be spent in complete weightless conditions during transit and possibly under exposure from harmful radiation. In addition, the prospects of recovery in case of an even minor malfunction are dire not to speak of a major accident of the type that occurred on Apollo 13. Being able to reduce the travel time to a matter of days, while transporting the crew under at least partial gravitational conditions completely changes the prospects for successful colonization of the Red Planet as well as the potential for a rescue mission should that be necessary [53].

4.2.4 A Thrust System for Safe, Low-Speed, Near-Earth Human Transportation

Propulsive System Specifications

a_{A}=6.29×10⁶ cm/s²
v_{A,fin}=1.61×10⁴ cm/s
Δt_{A}=2.55×10³ s
t_{ff}=60.6×10 s
Efficiency=11.2%
Δv_{craft}/cycle=18.35 cm/s
a_{craft}=g/2 (self-consistent)
Thrust=0.491 MN
(Thrust/Total Radiation Pressure)=4.20×10⁶
Earth-to-LEO distance=4×10⁷ cm
Total Travel time=4.97×10² s=8 min 17.5 s
Maximum Speed (reached at midpoint)=1.22×10⁵ cm/s=1.22 km/s
Maximum Kinetic Energy (reached at midpoint)=7.44×10¹⁶ erg
Total Energy Radiated (at midpoint)=1.74×10¹⁷ erg
Time to Mach 1 (Speed of Sound v_{sound}≅331 m/s)=67.5 s
Note: The quantities not repeated are unchanged with respect to the previous example.
   Comments

The interest of this particular case lies not in the acceleration, which is less favorable than by means of already available technology, but in its ability to deliver the entire payload to high altitude at rest. This allows us to consider an entirely new philosophy or air transportation and space travel around the Earth (or other planets). Whereas the key objective to reach extreme altitudes with ordinary technologies must be the achievement of high speeds, as that is the only strategy which allows the vehicle to be injected into a permanent orbit, in the case of the present invention it is possible to deliver a payload to a high hovering altitude without requiring orbital speeds.

Similarly, the descent maneuver of our vehicle does not require the fiery but unavoidable re-entry of typical deorbiting, thus avoiding the accompanying extreme heating and grave dangers to the crew, as in the recent Columbia tragedy. In fact, the vehicle of this example would not reach speeds higher than Mach 4 before decelerating to its hovering point, as opposed to the orbital re-entry speed of the Shuttle of approximately Mach 24. This achievement would represent nothing less than a revolution in aerospace technology. Interestingly, the present approach also lends itself to being phased-in as it replaces traditional propulsion technologies. In other words, it is conceivable that a system of lower thrust, unable by itself to attain a complete hover, could be placed into service for the only purpose to provide additional breaking in an emergency at those speeds that make parachute deployment am impossible option.

I claim:

1. An apparatus comprising:
at least one trap for confining particles;
a device for delivering electromagnetic radiation to the confined particles, wherein said device delivers an amount of electromagnetic radiation that is sufficient to:
(i) induce long-range interactions between said particles; and
(ii) cause said particles to either accelerate or hover.

2. The apparatus of claim 1 wherein said trap is an atomic trap.

3. The apparatus of claim 1 wherein said device is a laser.

4. The apparatus of claim 1 wherein said particles are characterized by a polarizability, wherein said particles have a polarizability that is greater than a static polarizability.

5. The apparatus of claim 1 wherein said electromagnetic radiation has a wavelength, and wherein said wavelength is a near-resonance wavelength.

6. The apparatus of claim 1 wherein said particles are Rydberg atoms.

7. The apparatus of claim 1 wherein said particles are neutral atoms.

8. The apparatus of claim 1 wherein said apparatus includes at least 1×10⁶ traps.

9. The apparatus of claim 1 further comprising a current controller, wherein said current controller causes said device for delivering electromagnetic radiation to deliver, at a minimum, an amount, W, of electromagnetic radiation, given by the expression:
$$W = 2.18 \times {10}^{9} \frac{{( \overline{R} / {a}_{0} )}^{3} {λ}_{L}^{2}}{{α}_{nr}^{2} ( {k}_{L} )}$$
wherein:
W: is power, in Megawatts;
\overline{R}/a₀: is the average interatomic distance, in Bohr radii;
λ_{L}: is the wavelength of the electromagnetic radiation, in micrometers;
αₙᵣ: is a factor (dimensionless) by which the static polarizability of a particle is increased at near resonance; and
k_{L}: is the laser light wave number (dimensionless).

10. The apparatus of claim 1 wherein said apparatus comprises a propulsion system, and wherein said propulsion system is coupled to a vehicle.

11. The apparatus of claim 10 further comprising an arrangement whereby said vehicle receives momentum from said particles.

12. The apparatus of claim 10 further comprising a surface upon which said particles are impacted, wherein said surface is coupled to said vehicle.

13. The apparatus of claim 12 wherein said surface is a part of a piston.

14. The apparatus of claim 10 wherein said vehicle is selected from the group consisting of helicopter, prop-driven aircraft, jet-aircraft, and space vehicle.

15. The apparatus of claim 10 further comprising a conventional propulsion system, wherein said conventional propulsion system is selected from the group consisting of a turboprop engine, a turbojet engine, a turbo-fan engine, ramjet engine, and chemical (rocket) engine.

16. The apparatus of claim 1 wherein said apparatus is coupled to freight.

17. An apparatus comprising:
a hull;
a first propulsion system, wherein said first propulsion system is disposed within said hull and comprises:
(a) at least one trap for confining particles; and
(b) a device for delivering electromagnetic radiation to the confined particles, wherein said device delivers an amount of electromagnetic radiation that is sufficient to:
(i) induce long-range interactions between said particles; and
(ii) cause said particles to accelerate;
(c) a surface against which said particles are impacted, wherein said surface couples to said hull; and
a source of energy for powering said device.

18. The apparatus of claim 17 comprising a second propulsion system, wherein said second propulsion system is selected from the group consisting of a turboprop engine, a turbojet engine, a turbo-fan engine, a ramjet engine, and chemical (rocket) engine.

19. An apparatus comprising:
at least one atomic trap for confining particles;
at least one laser for delivering electromagnetic radiation to the confined particles;
a power source for powering said laser; and
a controller for controlling said laser, wherein said controller, in conjunction with said power source, provide an amount of current to said laser that is sufficient to cause said laser to deliver an amount of electromagnetic radiation that is sufficient to:
(i) induce long-range interactions between said particles; and
(ii) cause said particles to accelerate or hover.

20. The apparatus of claim 19 further comprising a conventional propulsion system.
